(19) United States
(12) Patent Application Publication
(10) Pub. No.: US 2009/0317617 A1
(43) Pub. Date: Dec. 24, 2009

(54) BASE MEMBER WITH BINDING FILM, BONDING METHOD, AND BONDED STRUCTURE

(75) Inventors: Mitsuru SATO, Suwa (JP); Takatoshi YAMAMOTO, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/484,316

(22) Filed: Jun. 15, 2009

(30) Foreign Application Priority Data
Jun. 19, 2008 (JP) 2008-161042

(51) Int. Cl. C09J 7/02; B32B 37/00

(52) U.S. Cl. 428/220; 428/343; 428/344; 428/704; 156/272.2

(57) ABSTRACT

A bonding film-formed base member includes a base member and a bonding film formed by supplying a liquid material containing a metal complex on a surface of the base member and then drying and burning the liquid material. The bonding film includes a metal atom and a leaving group made of an organic component. In the bonding-film formed base member, energy is applied to at least a partial region of a surface of the bonding film to eliminate the leaving group present near the surface of the bonding film from the bonding film so as to allow the at least a partial region of the surface to have adhesion to an object intended to be bonded to the bonding film-formed base member.

The entire disclosure of Japanese Patent Application No. 2008-161042, filed Jun. 19, 2008 is expressly incorporated by reference herein.

### BACKGROUND

1. Technical Field

The present invention relates to a base member with a bonding film, a bonding method, and a bonded structure.

2. Related Art

Conventionally, two base members are bonded (adhered) to each other by an adhesive such as an epoxy, urethane, or silicone adhesive.

Regardless of materials of members to be bonded, such an adhesive generally provides high adhesion to achieve bonding between various combinations of members made of different materials.

For example, a liquid droplet discharging head (an inkjet recording head) incorporated in inkjet printers includes components made of different materials such as resin, metal, or silicon, which are bonded together by using an adhesive,

In order to bond members together by using an adhesive, first, a liquid or paste adhesive is applied to a bonded surface of at least one of the members to adhere them together via the adhesive applied. Then, heat or light is applied to cure (solidify) the adhesive, thereby obtaining a structure including the members bonded together.

However, the adhesive-based bonding has problems such as low bonding strength, low size precision, and a time-consuming bonding process because of a long curing time required for such an adhesive.

Additionally, in many cases, a primer is needed to increase bonding strength. Cost and time for use of the primer results in an increase in bonding cost and complication of the bonding process.

Meanwhile, for bonding without using any adhesive there is disclosed a solid-to-solid bonding method.

In the method, without any intermediate layer such as an adhesive, components are directly bonded to each other (See JP-A-1993-82404, for example).

The above bonding method can provide a bonded structure with high size precision, since the method uses no intermediate layer such as an adhesive.

In the solid-to-solid bonding method, however, there are several problems as follows: (1) Materials of bonded members are restricted; (2) The bonding process requires heating at a high temperature (ranging approximately from 700 to 800° C., for example); and (3) An atmosphere during the bonding process is restricted to a reduced-pressure atmosphere.

Given the problems described above, there has been a demand for a method for bonding members together strongly with high size precision and efficiently at a low temperature regardless of the materials of the bonded members.

### SUMMARY

An advantage of the present invention is to provide a bonding film-formed base member including a bonding film that can be bonded to an object intended to be bonded, strongly with high size precision and efficiently at a low temperature. Another advantage of the invention is to provide a bonding method for bonding the bonding film-formed base member and the intended object together at a low temperature and efficiently. Still another advantage of the invention is to provide a highly reliable bonded structure obtained by bonding the bonding film-formed structure and the intended object together strongly with high size precision.

Those advantages are attained by aspects and features described below.

A bonding film-formed base member according to a first aspect of the invention includes a base member and a bonding film formed by supplying a liquid material containing a metal complex on a surface of the base member and then drying and burning the liquid material. The bonding film includes a metal atom and a leaving group made of an organic component. In the bonding-film formed base member, energy is applied to at least a partial region of a surface of the bonding film to eliminate the leaving group present near the surface of the bonding film from the bonding film so as to allow the at least a partial region of the surface to have adhesion to an object intended to be bonded to the bonding film-formed base member.

Thereby, there can be obtained the bonding film-formed base member that includes the bonding film that can be bonded to an object intended to be bonded, strongly with high size precision and efficiently at a low temperature.

In the bonding film-formed base member of the aspect, preferably, the leaving group is a part of an organic substance included in the metal complex of the liquid material and remains in the bonding film formed by drying and then burning the liquid material.

In the base member, the a part of the organic substance remaining in the bonding film formed is used as the leaving group. It is thus unnecessary to introduce any leaving group in the formed metal film, so that the bonding film can be obtained through a relatively simple process.

In bonding film-formed base member of the aspect, preferably, the liquid material is burned at a temperature ranging from 70 to 300° C.

Setting the burning temperature within the above range ensures that the organic substance included in the metal complex is eliminated from the metal complex while allowing the a part of the organic substance to remain. Accordingly, with application of energy to the surface of the bonding film, it can be ensured that the bonding film suitably obtains adhesion.

In the bonding film-formed base member of the aspect, preferably, the liquid material is burned under an inert gas atmosphere.

Thereby, without forming any pure metal film on the base member, the bonding film can be formed under the condition allowing the a part of the organic substance included in the metal complex to remain. Consequently, the formed bonding film has excellent characteristics both as the bonding film and the metal film.

In bonding film-formed base member of the aspect, preferably, the liquid material is burned under a reduced pressure.

This can increase density of the formed bonding film to further improve strength of the bonding film.

In bonding film-formed base member of the aspect, preferably, the leaving group includes an atomic group having a carbon atom as an essential component and at least one of a hydrogen atom, a nitrogen atom, an oxygen atom, a phosphorous atom, a sulfur atom, and a halogen atom.

The leaving group including the atomic group is relatively excellent in selectivity between binding and elimination by application of energy. Accordingly, with application of energy, the leaving group can be relatively easily and evenly eliminated, thereby further increasing adhesion of the bonding film-formed base member.

Preferably, the leaving group includes an alkyl group as the atomic group.

Since a leaving group including an alkyl group exhibits chemical stability, the bonding film including an alkyl group as the leaving group is excellent in weather resistance and chemical resistance.

In the bonding film-formed base member of the aspect, preferably, the metal atom is at least one of copper, aluminum, zinc, iron, and ruthenium.

The bonding film including at least one of the above metal atoms can exhibit excellent conductivity.

In the bonding film-formed base member of the aspect, preferably, a ratio between the metal atom and a carbon atom included in the bonding film ranges from 3:7 to 7:3.

Setting the ratio between the metal atom and the carbon atom in the bonding film within the above range allows stability of the bonding film to be increased, thereby enabling bonding between the bonding film-formed base member and an opposing base plate to be further strengthened. In addition, the bonding film can exhibit excellent conductivity.

In the bonding film-formed base member of the aspect, preferably, the bonding film has conductivity.

Thereby, when the bonding film-formed base member of the aspect is bonded to an object intended to be bonded, the bonding film can be applied to a wiring, a terminal or the like included in a wiring board.

In the bonding film-formed base member of the aspect, preferably, after the leaving group present at least near the surface of the bonding film is eliminated from the bonding film, an active bond occurs on the surface of the bonding film.

Thereby, based on chemical bonding, the bonding film-formed base member can be strongly bonded to an object intended to be bonded together.

In the bonding film-formed base member, preferably, the active bond is a dangling bond or a hydroxyl group.

Thereby, the bonding film-formed base member can be particularly strongly bonded to an object intended to be bonded together.

In the bonding film-formed base member of the aspect, preferably, the bonding film has an average thickness of 1 to 1000 nm.

Setting the average thickness of the bonding film within the above range can prevent significant reduction in size precision of a bonded structure obtained by bonding the bonding film-formed base member and the intended object to each other, as well as can increase the bonding strength between the base member and the intended object.

In the bonding film-formed base member of the aspect, preferably, the bonding film is a solid having no fluidity.

Thereby, the bonded structure obtained using the bonding film-formed base member has a higher size precision than in any other known art. In addition, as compared to the known art, strong bonding can be achieved in a short time.

In the bonding film-formed base member of the aspect, preferably, the base member is plate-shaped.

Thereby, the base member can be easily bent and can be sufficiently deformed along a shape of an object intended to be bonded together, thus further increasing adhesion between the base member and the intended object. In addition, bending of the base member allows stress occurring at a bonded interface to be mitigated to some extent.

In the bonding film-formed base member of the aspect, preferably, at least a region of the base member where the bonding film is to be formed is mainly made of silicon, metal, or glass.

Thereby, without any surface treatment, sufficient bonding strength can be obtained.

In the bonding film-formed base member of the aspect, preferably, a surface treatment for increasing adhesion to the bonding film is performed in advance on the surface of the base member where the bonding film is to be formed.

This can clean and activate the surface of the base member to increase bonding strength between the bonding film and the opposing base plate.

In addition, preferably, the surface treatment is a plasma treatment.

This can particularly optimize the surface of the base member to form the bonding film thereon.

The bonding film-formed base member of the aspect, preferably, further includes an intermediate layer provided between the base member and the bonding film.

Thereby, there can be obtained a highly reliable bonded structure.

Preferably, the intermediate layer is mainly made of an oxide material.

This can particularly increase the bonding strength between the base member and the bonding film.

A bonding method according to a second aspect of the invention includes preparing the bonding film-formed base member according to the first aspect and the object intended to be bonded together, applying energy to at least a partial region of the bonding film included in the bonding film-formed base member, and bonding the bonding film-formed base member and the intended object together such that the bonding film closely adheres to the intended object so as to obtain a bonded structure.

Thereby, the bonding film-formed base member can be efficiently bonded to the intended object at a low temperature.

A bonding method according to a third aspect includes preparing the bonding film-formed base member according to the first aspect and the object intended to be bonded together, laminating the bonding film-formed base member and the intended object together such that the bonding film closely contacts with the intended object so as to obtain a laminate, and applying energy to at least a partial region of the bonding film included in the laminate to bond the bonding film-formed base member and the intended object together so as to obtain a bonded structure.

This allows the bonding film-formed base member and the intended object to be efficiently bonded together at a low temperature. Additionally, in the condition where the laminate is obtained, the bonding film-formed base member and the intended object are not bonded together yet. Thus, relative positions between the bonding film-formed base member and the intended object can be easily adjusted after the bonding film-formed base member and the intended object are laminated one on top of the other. As a result, positional precision in a surface direction of the bonding film can be increased.

In the bonding method of the second aspect, preferably, the energy is applied by using at least one method among application of an energy beam to the bonding film, heating of the bonding film, and application of a compressive force to the bonding film.

Thereby, the energy application to the bonding film can be relatively easily and efficiently performed.

Preferably, in the above bonding method, the energy beam is UV light having a wavelength of 126 to 300 nm.

This can optimize an amount of the energy applied to the bonding film, thereby ensuring elimination of the leaving group in the bonding film. As a result, the bonding film can obtain adhesion while preventing deterioration in the characteristics (mechanical characteristics, chemical characteristics, and the like) of the bonding film.

Preferably, in the bonding method, a heating temperature ranges from 25 to 200° C.

This can surely prevent degeneration or deterioration of the bonded structure due to heat, ensuring an increase in the bonding strength of the structure.

Preferably, in the bonding method, the compressive force ranges from 0.2 to 10 MPa.

This can prevent damage or the like from being caused to the base plate or the object intended to be bonded together due to excessive pressure, and the bonding strength of the bonded structure can be surely increased.

In the bonding method of the second aspect, preferably, the energy is applied under an air atmosphere.

This can save time, effort, and cost for atmosphere control, thereby further facilitating application of the energy.

In the bonding method of the second aspect, preferably, the object intended to be bonded together has a surface that is in advance subjected to a surface treatment for increasing adhesion to the bonding film; and the bonding film-formed base member is bonded to the intended object such that the bonding film closely adheres to the surface of the intended object subjected to the surface treatment.

This can further increase the bonding strength between the bonding film-formed base member and the intended object.

In the bonding method of the second aspect, preferably, the object intended to be bonded together has, in advance, a surface including at least one group or substance selected from a functional group, a radical, an open-circular molecule, an unsaturated bond, a halogen, and a peroxide, and the bonding film-formed base member is bonded to the intended object such that the bonding film closely adheres to the surface of the intended object including the at least one group or substance.

This can sufficiently increase the bonding strength between the bonding film-formed base member and the object intended to be bonded to the base member.

The bonding method of the second aspect, preferably, further includes performing a treatment for increasing bonding strength of the bonded structure for the bonded structure.

This can further improve the bonding strength of the bonded structure.

Preferably, the treatment for increasing the bonding strength includes at least one method among application of an energy beam to the bonded structure, heating of the bonded structure, and application of a compressive force to the bonded structure.

This can facilitate a further increase in the bonding strength of the bonded structure.

A bonded structure according to a fourth aspect of the invention includes the bonding film-formed base member according to the first aspect and an object bonded to the bonding film-formed base member via the bonding film.

Thereby, there can be a highly reliable bonded structure obtained by bonding the bonding film-formed base member and the intended object together strongly with high size precision.

A bonded structure according to a fifth aspect of the invention includes two bonding film-formed base members, each of which is same as the bonding film-formed base member according to the first aspect, the two bonding film-formed base members being bonded together such that the bonding films of the base members are opposed to each other.

Thereby, a highly reliable bonded structure can be obtained by bonding the two bonding film-formed base members together strongly with high size precision.

### BRIEF DESCRIPTION OF THE DRAWINGS

The invention will be described with reference to the accompanying drawings, wherein like numbers reference like elements.

FIGS. 1A to 1C are longitudinal sectional views illustrating a method for bonding a bonding film-formed base member to an opposing base plate according to a first embodiment of the invention by using a bonding film-formed base member according to a first embodiment of the invention.

FIGS. 2D to 2F are longitudinal sectional views illustrating the bonding method according to the first embodiment by using the bonding film-formed base member of the first embodiment.

FIG. 3 is a partially enlarged view showing a condition of a bonding film included in the bonding film-formed base member of the embodiment before application of energy.

FIG. 4 is a partially enlarged view showing a condition of the bonding film after the application of energy.

FIGS. 5A to 5D are longitudinal sectional views illustrating a method for bonding a bonding film-formed base member to an opposing base plate according to a second embodiment of the invention by using the bonding film-formed base member of the first embodiment.

FIGS. 6A to 6D are longitudinal sectional views illustrating a method for bonding a bonding film-formed base member to an opposing base plate according to a third embodiment of the invention by using two bonding film-formed base members, each of which is same as that of the first embodiment.

FIGS. 7E and 7F are longitudinal sectional views illustrating the method for bonding a bonding film-formed base member to an opposing base plate according to the third embodiment of the invention by using the bonding film-formed base members.

FIGS. 8A to 8D are longitudinal sectional views illustrating a method for bonding a bonding film-formed base member to an opposing base plate according to a fourth embodiment of the invention by using the bonding film-formed base member of the first embodiment.

FIGS. 9A to 9D are longitudinal sectional views illustrating a method for bonding a bonding film-formed base member to an opposing base plate according to a fifth embodiment of the invention by using a bonding film-formed base member according to a modification of the first embodiment.

FIGS. 10A to 10D are longitudinal sectional views illustrating a method for bonding a bonding film-formed base member to an opposing base plate according to a sixth embodiment of the invention by using the same two bonding film-formed base members as that of the first embodiment.

FIGS. 11A to 11D are longitudinal sectional views illustrating a method for bonding a bonding film-formed base member to an opposing base plate according to a seventh embodiment of the invention by using two bonding film-formed base members, each of which is same as that of the modification.

FIG. 12 is an exploded perspective view of an inkjet recording head (a liquid droplet discharging head) obtained by applying a bonded structure according to an embodiment of the invention.

FIG. 13 is a sectional view showing a structure of a main part of the inkjet recording head shown in FIG. 12.

FIG. 14 is a schematic view showing an example of an inkjet printer including the inkjet recording head shown in FIG. 12.

FIG. 15 is a perspective view showing a wiring board obtained by applying a bonded structure according to an embodiment of the invention.

### DESCRIPTION OF EXEMPLARY EMBODIMENTS

Some preferred exemplary embodiments of the invention will be described in detail with reference to the attached drawings.

A bonding film-formed base member according to a first embodiment of the invention includes a base plate (a base member) and a bonding film formed on the base plate. The bonding film-formed base member is bonded to an opposing base plate (an object intended to be bonded together in the embodiment).

In the bonding film-formed base member, the bonding film is an organic metal film including a metal atom and an organic leaving group and is obtained by drying and burning a liquid material that contains a metal complex.

In the bonding film-formed base member configured as above, energy is applied to at least a partial region of the bonding film, namely, an entire region of or a partial region of a bonded surface of the bonding film in a two-dimensional view, thereby allowing the leaving group present near the surface of the bonding film to be eliminated from the bonding film. Due to elimination of the leaving group, the surface region of the bonding film subjected to the application of energy obtains adhesion to the object intended to be bonded together.

The bonding film-formed base member thus characterized can be bonded to the opposing base plate strongly with high size precision and efficiently at a low temperature. Using the bonding film-formed base member as above, there can be formed a highly reliable bonded structure including the base plate and the opposing base plate that are strongly bonded together via the bonding film.

### First Embodiment

Hereinafter, a description will be given of each of the bonding film-formed base member according to the first embodiment of the invention, a method for bonding the bonding film-formed base member to the opposing base plate (the object intended to be bonded together) according to a first embodiment of the invention (a bonding method of the first embodiment), and a bonded structure including the bonding film-formed base member according to a first embodiment.

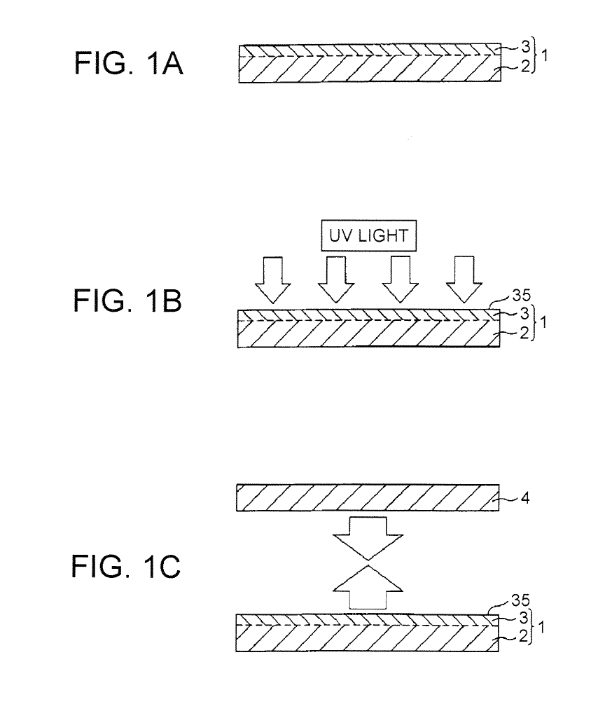

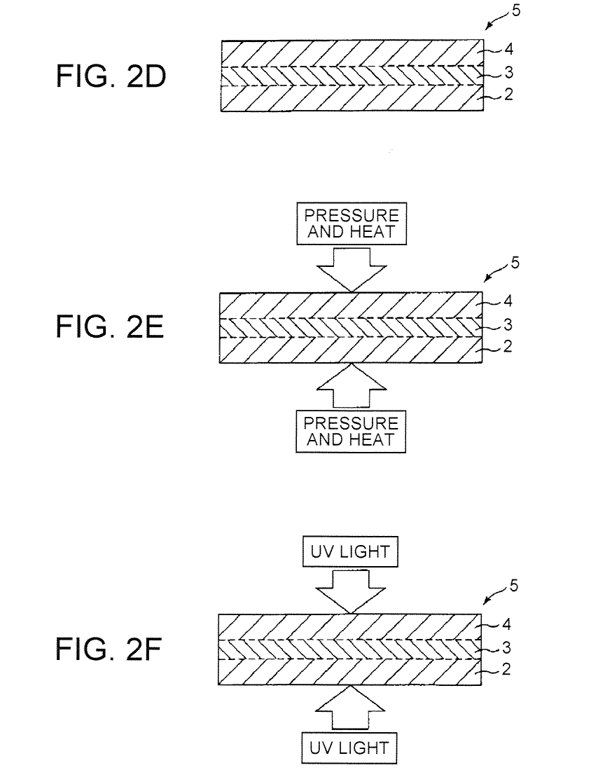

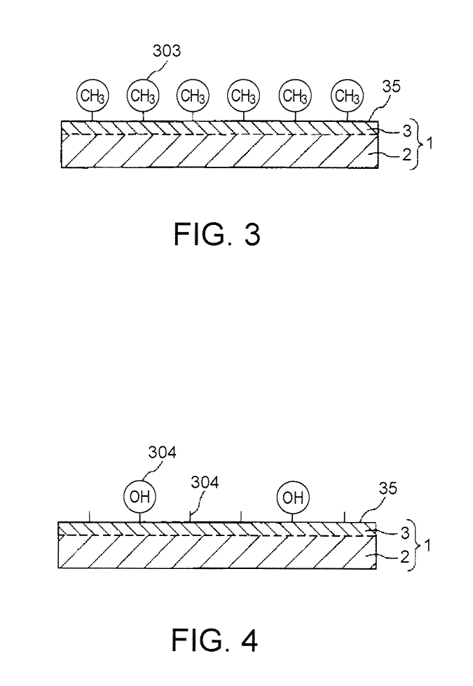

FIGS. 1A to FIG. 2F are longitudinal sectional views illustrating the bonding method of the first embodiment using the bonding film-formed base member of the first embodiment. FIG. 3 is a partially enlarged view showing a condition of the bonding film of the base member before application of energy, and FIG. 4 is a partially enlarged view showing a condition of the bonding film of the base member after application of energy.

In the description below, upper and lower sides, respectively, shown in FIGS. 1A to FIG. 4 will be referred to as “upper” and “lower”, respectively, in the drawings.

The bonding method of the first embodiment includes preparing the bonding film-formed base member of the first embodiment; applying energy to the bonding film of the base member to eliminate a leaving group from the bonding film so as to activate the bonding film; and preparing an opposing base plate (an object to be bonded together) to bond the opposing base plate to the base member such that the bonding film of the base member and the opposing base plate closely adhere to each other, so as to obtain a bonded structure.

Next will be described each step of the bonding method of the embodiment in a sequential order.

First, at step 1, there is prepared a bonding film-formed base member 1 (the bonding film-formed base member of the first embodiment). As shown in FIG. 1A, the bonding film-formed base member 1 includes a plate-shaped base plate (a base member) 2 and a bonding film 3 formed on the base plate 2.

The base plate 2 can be made of any material as long as the base plate 2 has rigidity enough to support the bonding film 3.

Specifically, examples of materials suitable for formation of the base plate 2 include polyolefins such as polyethylene, polypropylene, ethylene-propylene copolymer, and ethylene-vinyl acetate copolymer (EVA); polyesters such as cyclo-polyolefin, modified-polyolefin, polyvinyl chloride, polyvinylidene chloride, polystyrene, polyamide, polyimide, polyamide-imide, polycarbonate, poly-(4-methylpentene-1), ionomer, acryl resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polyethylene naphthalate, polybutylene terephthalate (PBT), and polycyclohexylenedimethylene terephthalate (PCT); thermosetting elastomers such as polyether, polyetherketone (PEK), polyether ether ketone (PEEK), polyetherimide, polyacetal (polyoxymethylene:POM), polyphenyleneoxide, modified-polyphenyleneoxide, polysulfone, polyethersulfone, polyphenylene sulfide, polyarylate, aromatic polyester (liquid crystal polymer), polytetrafluoroethylene, polyvinylidene fluoride, other fluororesins, stylenes, polyolefins, polyvinyl chlorides, polyurethanes, polyesters, polyamides, polybutadienes, trans-polyisoprenes, fluoro rubber, and chlorinated polyethylene; resins such as epoxy resin, phenol resin, urea resin, melamine resin, aramid resin, unsaturated polyester, silicone resin, polyurethane, copolymers mainly containing them, polymer blends, and polymer alloys; metals such as Fe, Ni, Co, Cr, Mn, Zn Pt, Au, Ag, Cu, Pd, Al, W, Ti, V, Mo, Nb, Zr Pr, Nd, and Sm, alloys of the metals, metallic materials such as carbon steel, stainless steel, indium-tin oxide (ITO), and gallium arsenide, silicon materials such as monocrystalline silicon, polycrystalline silicon, and amorphous silicon; glass materials such as borosilicate glass (silica glass), alkaline silicate glass, soda-lime glass, potash-lime glass, lead-alkali glass, barium glass, and borosilicate glass; ceramic materials such as alumina, zirconia, ferrite, silicon nitride, aluminum nitride, boron nitride, titanium nitride, silicon carbide, boron carbide, titanium carbide, tungsten carbide; carbon materials such as graphite, and composite materials including a combination of one kind or two or more kinds of the materials.

The base plate 2 may have a surface subjected to plating such as Ni plating, passivation such as chromating, nitriding, or the like.

In addition, the base plate 2 may not necessarily be plate-shaped and only needs to have a shape with a surface supporting the bonding film 3. For example, the base plate 2 may be block-shaped or bar-shaped.

In the present embodiment, the base plate 2, which has a plate-like shape, can be easily bent and thus is sufficiently deformable along a shape of an opposing base plate 4 described below, thereby further increasing adhesion between the base plate 2 and the opposing base plate 4. Additionally, in the bonding film-formed base member 1, adhesion between the base plate 2 and the bonding film 3 can also be increased, as well as bending of the base plate 2 can mitigate stress occurring at a bonded interface to some extent.

In this case, an average thickness of the base plate 2 is not specifically restricted but ranges preferably approximately from 0.01 to 10 mm and more preferably approximately from 0.1 to 3 mm. Additionally, preferably, an average thickness of the opposing base plate 4 described below is included in the same range as that of the average thickness of the base plate 2.

The bonding film 3 is positioned between the base plate 2 and the described-below opposing base plate 4 to serve to bond the base plates 2 and 4 together.

The bonding film 3 is obtained by drying and burning a metal complex-containing liquid material and includes a metal atom and a leaving group 303 made of an organic component (See FIG. 3).

The bonding film-formed base member according to the embodiment is mainly characterized by a structure of the bonding film 3, which will be described in detail below.

Preferably, in at least a region of the base plate 2 where the bonding film 3 is to be formed, a surface treatment in accordance with the material of the base plate 2 is performed in advance before forming the bonding film 3 to increase the adhesion between the base plate 2 and the bonding film 3.

For example, the surface treatment may be a physical surface treatment such as sputtering or blast treatment, a plasma treatment using oxygen plasma or nitrogen plasma, a chemical surface treatment such as corona discharge, etching, electron beam radiation, UV radiation, ozone exposure, or a combination of those treatments. Performing any of the surface treatments leads to cleaning of the region of the base plate 2 where the bonding film 3 is to be formed and activation of the region. This can increase the bonding strength between the bonding film 3 and the opposing base plate 4.

Among the surface treatments, using the plasma treatment particularly allows optimization of the surface of the base plate 2 to form the bonding film 3.

As a surface treatment for the base plate 2 made of a resin material (a high polymer material), a surface treatment using corona discharge, nitrogen plasma, or the like may be particularly suitable.

Depending on the material of the base plate 2, without any surface treatment, the bonding film 3 can obtain a sufficiently high bonding strength. Materials for the base plate 2 exhibiting the advantageous effect may mainly contain any of the metallic materials, the silicon materials, the glass materials, or the like as mentioned above.

The surface of the base plate 2 made of any of the above materials is covered with an oxide film, where a relatively highly active hydroxyl group is bound to a surface of the oxide film. Thus, using the base plate 2 made of such a material enables the bonding film-formed base member 1 (the bonding film 3) to be strongly bonded to the opposing base plate 4 without performing any surface treatment as above.

In this case, an entire part of the base plate 2 may not necessarily be made of any of the materials above. It is only necessary that a part near a surface of the at least a region of the base plate 2 where the bonding film 3 is to be formed is made of any of the above materials.

As an alternative to the surface treatment, an intermediate layer may be formed in advance in the at least a region of the base plate 2 where the bonding film 3 is to be formed.

The intermediate layer can have any function, which is not specifically restricted. For example, preferably, the intermediate layer has a function of increasing the adhesion between the base plate 2 and the bonding film 3, a cushioning function (a buffer function), a function of mitigating stress concentration, a function (a seed layer) of promoting film growth of the bonding film 3 in formation of the bonding film 3, a function (a barrier layer) of protecting the bonding film 3, or the like. Then, bonding the base plate 2 to the bonding film 3 via the intermediate layer as above allows a highly reliable bonded structure to be obtained.

Examples of materials for the intermediate layer include metals such as aluminum, titanium, tungsten, copper, and alloys thereof, oxide materials such as an metal oxide and a silicon oxide, nitride materials such as a metal nitride and a silicon nitride, carbons such as graphite and diamond-like carbon, and self-organizing film materials such as a silane coupling agent, a thiol compound, a metal alkoxide, and a metal-halogen compound, resin materials such as resin adhesives, resin films, resin coating materials, rubber materials, and elastomers. Among them, one kind thereof or a combination of two or more kinds thereof may be used as the material for the intermediate layer.

Particularly, among those kinds of the materials, using any of the oxide materials as the material for the intermediate layer can increase the bonding strength between the base plate 2 and the bonding film 3.

Next, at step 2, energy is applied to a surface 35 of the bonding film 3 of the bonding film-formed base member 1.

With energy to the bonding film 3 applied, as shown in FIGS. 3 and 4, a bond of the leaving group 303 included in the bonding film 3 is separated; then, the leaving group 303 is eliminated from near the surface 35 of the bonding film 3; and an active bond occurs near the surface 35 thereof. As a result, the surface 35 of the bonding film 3 obtains adhesion to the opposing base plate 4.

In the above condition, the bonding film-formed base member 1 can be strongly bonded to the opposing substrate 4 based on chemical bonding.

The energy applied to the bonding film 3 can be applied using any method. For example, there may be mentioned energy beam irradiation to the bonding film 3, heating of the bonding film 3, compression (physical energy) application to the bonding film 3, plasma exposure (plasma energy application) to the bonding film 3, ozone-gas exposure (chemical energy application) to the bonding film 3, and the like. Particularly, among those methods, in the present embodiment, preferably, the energy beam irradiation is used as a method for applying energy to the bonding film 3. The energy beam irradiation method allows energy to be applied to the bonding film 3 in a relatively easy and efficient manner, and thus is used as a suitable energy application method.

In that case, the energy beam may be light such as a laser beam or UV light, a corpuscular beam such as an X ray, a gamma ray, an electron ray, or an ion beam, a combination of two or more kinds of them.

Particularly, among them, it is preferable to use UV light having a wavelength of approximately 126 to 300 nm (See FIG. 1B). Using UV light having a wavelength within the above range can lead to optimization of an amount of energy applied, thereby ensuring elimination of the leaving group 303 from the bonding film 3. This can prevent reduction in characteristics (such as mechanical and chemical characteristics) of the bonding film 3, and can ensure that the bonding film 3 has adhesion.

In addition, the use of UV light allows energy to be evenly applied to the bonding film 3 in a short-time within a wide range, thus efficiently facilitating elimination of the leaving group 303. Furthermore, the use of UV light is advantageous in that UV light can be generated using simple equipment such as a UV lamp.

UV light to be used has a wavelength of more preferably approximately 126 to 200 nm.

When using an UV lamp, an output level of the UV lamp varies with a size of the bonding film 3. The output level thereof ranges preferably approximately from 1 mW/cm² to 1 W/cm², and more preferably approximately from 5 to 50 mW/cm². In this case, a distance between the UV lamp and the bonding film 3 is preferably approximately 1 to 10 mm, and more preferably approximately 1 to 5 mm.

Preferably, the UV light is applied for a certain length of time where the leaving group 303 is eliminated from near the surface 35 of the bonding film 3, namely for a length of time where the UV light is not unnecessarily applied to the bonding film 3. Thereby, degeneration and deterioration of the bonding film 3 can be effectively prevented. Specifically, a UV light irradiation time is preferably approximately 0.5 to 30 minutes and more preferably approximately 1 to 10 minutes, although the irradiation time slightly varies according to an amount of UV light, the material of the bonding film 3, and the like.

The UV light may be applied continuously or intermittently (in a pulse-form) for a predetermined time.

On the other hand, examples of the laser beam include pulse oscillation lasers (pulse lasers) such as excimer lasers and continuous oscillation lasers such as carbon dioxide lasers and semiconductor lasers. Particularly, pulse lasers are preferably used. In the pulse lasers, as time passes, heat is hardly accumulated in a region of the bonding film 3 subjected to laser beam irradiation. This can surely prevent degeneration and deterioration of the bonding film 3 due to accumulated heat. In other words, using a pulse laser can prevent influence of accumulated heat in an inside of the bonding film 3.

When considering influence of heat, the pulse laser has preferably as short a pulse width as possible. Specifically, the pulse width is preferably equal to or less than 1 ps (picosecond), and more preferably equal to or less than 500 fs (femtoseconds). Setting the pulse width in the above range can appropriately suppress the influence of heat generated on the bonding film 3 due to irradiation of laser beam. A pulse laser having a pulse width as short as in the above range is called as a “femtosecond laser”.

A wavelength of the laser beam applied is not specifically restricted. For example, the laser beam has a wavelength of preferably approximately 200 to 1200 nm and more preferably approximately 400 to 1000 nm.

A peak output of the laser beam varies with each pulse width in case of the pulse laser. The peak output of the laser beam is preferably approximately 0.1 to 10 W and more preferably approximately 1 to 5 W.

A repetition frequency of the pulse laser is preferably approximately 0.1 to 100 kHz and more preferably approximately 1 to 10 kHz. Setting the frequency of the pulse laser in the above range allows a temperature in the region subjected to the laser beam irradiation to be significantly increased. Thereby, the leaving group 303 can be surely detached from near the surface 35 of the bonding film 3 in a condition where a part of an organic component included in the bonding film 3 remains.

Conditions for the laser beam irradiation are preferably appropriately adjust such that the temperature in the laser-irradiated region ranges preferably approximately from room temperature to 600° C., more preferably approximately from 200 to 600° C., still more preferably approximately from 300 to 400° C. Thereby, the temperature of the laser-irradiated region is significantly increased, thereby enabling the leaving group 303 to be surely eliminated from the bonding film 3 while a part of the organic component included in the bonding film 3 remains.

Preferably, the laser beam applied to the bonding film 3 is moved (scanning) along the surface 35 of the bonding film 3 while placing a focus of the laser beam on the surface 35 thereof. Thereby, heat generated by irradiation of the laser beam is locally accumulated near the surface 35. As a result, the leaving group 303 present on the surface 35 of the bonding film 3 can be selectively detached from the surface.

The energy beam irradiation to the bonding film 3 can be in any atmosphere such as air, an atmosphere of an oxidizing gas such as oxygen, an atmosphere of a reducing gas such as hydrogen, an atmosphere of an inert gas such as nitrogen or argon, or a pressure-reduced (vacuum) atmosphere in which pressure in any of the atmospheres has been reduced. Particularly, the energy beam irradiation is preferably performed in air atmosphere. Thereby, control of the atmosphere does not require any time or cost, thus further facilitating the energy beam irradiation.

Accordingly, in the method for irradiating an energy beam as above, energy can be easily applied selectively to a vicinity of the surface 35 of the bonding film 3. This can prevent, for example, degeneration or deterioration of the base plate 2 and the bonding film 3 due to the energy beam application.

Additionally, in the energy beam irradiation method above, a magnitude of the energy applied can be easily adjusted with high precision. This allows adjustment of an amount of the leaving group 303 eliminated from the bonding film 3. Then, adjusting the amount of the leaving group 303 leaving therefrom can facilitate control of a bonding strength between the bonding film-formed base member 1 and the opposing base plate 4.

Specifically, increasing the amount of the leaving group 303 eliminated allows many more active bonds to occur near the surface 35 of the bonding film 3, whereby the adhesion occurring on the bonding film 3 can be further increased. Conversely, reducing the amount of the leaving group 303 eliminated leads to reduction of active bonds occurring near the surface 35 of the bonding film 3, thereby enabling the occurrence of adhesion on the bonding film 3 to be suppressed.

In order to adjust the magnitude of the energy applied, for example, it is only necessary to adjust conditions such as a kind of the energy beam, an output level thereof, and an irradiation time thereof.

Furthermore, in the energy beam irradiation method, a large amount of energy can be applied in a short time, thus achieving more efficient energy beam irradiation.

As shown in FIG. 3, the bonding film 3 before application of the energy beam is in a condition of having the leaving group 303 near the surface 35 of the film. When the energy beam is applied to the bonding film 3 under that condition, the leaving group 303 (a methyl group in FIG. 3) is eliminated from the surface of the bonding film 3. Then, as shown in FIG. 4, an active bond 304 is generated and activated, thereby causing the surface of the bonding film 3 to be adhesive.

In the present specification, a condition where the bonding film 3 is “activated” means a condition where the leaving group 303 present on the surface 35 of and in the inside of the bonding film 3 is eliminated from near the film and thereby a non-terminated bond (hereinafter referred to as “broken bond” or “dangling bond”) occurs in an atomic structure of the bonding film 3. In addition, the activated condition of the bonding film 3 means a condition where the broken bond has a hydroxyl group (an OH group) at an end thereof, and a mixed condition where a dangling bond exists and an OH group is bound at an end of a dangling bond.

Accordingly, the active bond 304 is referred to as the dangling bond or the dangling bond having the OH group at an end thereof, as shown in FIG. 4. Using the bonding film 3 containing the active bond 304 as above allows a particularly strong bonding between the film 3 and the opposing base plate 4.

The latter condition (where the OH group is bound at the end of the dangling bond) is easily obtained, for example, by applying an energy beam to the bonding film 3 in an air atmosphere to cause moisture molecules in the air to bond at the end of the dangling bond.

In addition, the present embodiment has described energy application to the bonding film 3 of the base member 1 performed in advance before bonding the bonding film-formed base member 1 to the opposing base plate 4. However, the energy application may be performed when or after the bonding film-formed base member 1 and the opposing base plate 4 are bonded together (the base plates are laminated one on top of the other). This will be described in a following embodiment.

Next, at step 3, the opposing base plate (the object to be bonded together) 4 is prepared. Then, as shown in FIG. 1C, the bonding film-formed base member 1 and the opposing base plate 4 are bonded together such that the active bonding film 3 closely adheres to the opposing base plate 4. At step 2 above, it is shown that the bonding film 3 has adhesion to the opposing base plate 4. Accordingly, chemical bonding between the bonding film 3 and the opposing base plate 4 allows formation of a bonded structure 5 as shown in FIG. 2D.

The bonded structure 5 thus formed does not use adhesion mainly based on a physical bonding such as an anchor effect, like an adhesive used in the conventional bonding method. Instead, a strong chemical bonding occurring in a short time, such as a covalent bond, is used to bond the bonding film-formed base member 1 and the opposing base plate 4 to each other. Thus, the bonded structure 5 can be formed in a short time, as well as it is extremely seldom that separation between the base member 1 and the opposing base plate 4, bonding unevenness, and the like occur.

Furthermore, forming the bonded structure 5 by using the bonding film-formed base member 1 does not require any heat treatment at a high temperature (such as 700° C. or higher) as in a solid-to-solid bonding method in related art). Thus, the base plate 2 and the opposing base plate 4 each made of a material having low heat resistance can be bonded together.

In addition, the base plate 2 and the opposing base plate 4 are bonded to each other via the bonding film 3, so that there is no restriction regarding the materials of the base plates 2 and 4.

Therefore, the embodiment can broaden a selection range of each material of the base plates 2 and 4.

In the solid-to-solid bonding, any bonding film is not used. Accordingly, when there is a significant difference in thermal expansion coefficient between the base plate 2 and the opposing base plate 4, stress due to the difference tends to be concentrated on the bonded interface between the base plates 2 and 4, whereby separation therebetween can be caused. However, in the bonded structure 5 (the bonded structure of the embodiment), the bonding film 3 can mitigate stress concentration, thereby appropriately suppressing or preventing occurrence of the separation.

Additionally, in the present embodiment, the bonding film 3 is formed on only one of the base plate 2 and the opposing base plate 4 bonded together (only on the base plate 2 in the embodiment). Accordingly, when forming the bonding film 3 on the base plate 2, the base plate 2 is likely to be exposed to a high-temperature environment for relatively long hours depending on how to form the bonding film 3. However, in the embodiment, the opposing base plate 4 is not exposed to a high temperature.

Thus, for example, even when the opposing base plate 4 is made of a relatively low heat resistant material, the bonding method of the embodiment allows strong bonding between the bonding film-formed base member 1 and the opposing base plate 4. Consequently, the material of the opposing base plate 4 can be selected among a broad range of materials without little consideration of heat resistance.

The opposing base plate 4 prepared may be made of any material, as in the base plate 2.

Specifically, the opposing base plate 4 may be the same material as that of the base plate 2.

In addition, as in the base plate 2, the opposing base plate 4 may also have any shape as long as the shape of the base plate 4 has a surface to which the bonding film 3 closely adheres. The opposing base plate 4 may have a plate-like (layer-like), block-like, or bar-like shape, for example.

Although the material of the opposing base plate 4 may be different from or the same as that of the base plate 2, thermal expansion coefficients of the base plates 2 and 4 are preferably approximately equal to each other. Equalizing approximately the thermal expansion coefficients of the base plates 2 and 4 suppresses the occurrence of stress due to thermal expansion on the bonded interface between the bonding film-formed base member 1 and the opposing base plate 4 bonded together. As a result, in the bonded structure 5 finally obtained, defects such as separation can surely be prevented.

Although described in detail later, even when the thermal expansion coefficients of the base plate 2 and the opposing base plate 4 are different from each other, conditions for bonding the bonding film-formed base member 1 to the opposing base plate 4 are preferably optimized as below. Thereby, the bonding film-formed base member 1 and the opposing base plate 4 can be strongly bonded together with high size precision.

When the base plates 2 and 4 have different thermal expansion coefficients, the base member 1 and the opposing base plate 4 are bonded together, preferably, at as low a temperature as possible. Bonding at a low temperature can further reduce thermal stress occurring at the bonded interface.

The optimum conditions vary depending on the difference between the thermal expansion coefficients of the base plate 2 and the opposing base plate 4. Specifically, the bonding film-formed base member 1 is bonded to the opposing base plate 4 in a condition where a temperature of each of the base plates 2 and 4 is, preferably, in a range of approximately 25to 50° C., and more preferably, in a range of approximately 25 to 40° C. In the above temperature range, the thermal stress occurring at the bonded interface can be sufficiently reduced even when the difference in the thermal expansion coefficient between the base plates 2 and 4 is large to some extent. As a result, in the bonded structure 5, occurrence of defects such as bending and separation can be surely suppressed or prevented.

In that case, when a specific difference in the thermal expansion coefficient between the base plate 2 and the opposing base plate 4 is equal to or larger than 5×10⁻⁵/K, it is particularly recommended that bonding is performed at as low a temperature as possible as described above.

Furthermore, preferably, the base plate 2 and the opposing base plate 4 have different rigidity. Thereby, the bonding film-formed base member 1 and the opposing base plate 4 can be more strongly bonded to each other.

At least one of the base plate 2 and the opposing base plate 4 is preferably made of a resin material. The resin material has flexibility, which can mitigate stress occurring at the bonded interface (such as stress due to thermal expansion) when bonding the bonding film-formed base member 1 to the opposing base plate 4. This inhibits destruction of the bonded interface, resulting in formation of the bonded structure 5 with high bonding strength.

Similarly to the base plate 2, preferably, a surface treatment for increasing adhesion between the base plate 2 and the bonding film 3 is performed on a region of the opposing base plate 4 bonded to the bonding film-formed base member 1 as described above, in advance before being bonded to the base member 1, in accordance with the material of the opposing base plate 4. This can further increase the adhesion between the bonding film-formed base member 1 and the opposing base plate 4.

The surface treatment may be the same as that performed on the base plate 2 as described above.

Depending on the material of the opposing base plate 4, the above surface treatment may not be needed, and the bonding strength between the bonding film-formed base member 1 and the opposing base plate 4 can be sufficiently increased. In order to obtain such an advantageous effect, the opposing base plate 4 may be made of the same material as that of the base plate 2 described above, such as a metal, silicon, or glass material.

Additionally, when the region of the opposing base plate 4 bonded to the bonding film-formed base member 1 has at least one group or substance as mentioned below, the bonding strength between the base member 1 and the opposing base plate 4 can be sufficiently increased without any surface treatment as above.

For example, the group or substance may be at least one group or substance selected from a group including a hydrogen atom, a functional group such as a hydroxyl group, a thiol group, a carboxyl group, an amino group, a nitro group, or an imidazole group, a radial, an open-ring molecule, an unsaturated bond such as a double bond or a triple bond, a halogen such as F, Cl, Br, or I, and a peroxide. The surface of the above region having the group or substance enables the bonding strength between the bonding film-formed base member 1 and the bonding film 3 to be further increased.

In order to allow the surface of the opposing base plate to have the group or substance as above, any of the surface treatments above may be selected according to need. Thereby, the opposing base plate 4 can be particularly strongly bonded to the bonding film-formed base member 1.

As an alternative to the surface treatment as above, preferably, an intermediate layer for increasing adhesion to the bonding film 3 is formed in advance on the region of the opposing base plate 4 that is to be bonded to the bonding film-formed base member 1. Thereby, the bonding film-formed base member 1 is bonded to the opposing base plate 4 via the intermediate layer so as to obtain the bonded structure 5 having a higher bonding strength.

The intermediate layer may be made of the same material as that of the intermediate layer formed on the base plate 2 as described above.

Now will be described a mechanism for bonding the bonding film-formed base member 1 to the opposing base plate 4 at the present step.

Here is introduced an example in which a hydroxyl group is exposed on the region of the opposing base plate 4 bonded to the bonding film-formed base member 1. At the present step, when the bonding film 3 of the base member 1 is bonded to the opposing base plate 4 such that the film 3 is contacted with the base plate 4, a hydroxyl group on the surface 35 of the bonding film 3 of the bonding film-formed base member 1 and a hydroxyl group on the above region of the opposing base plate 4 attract each other by hydrogen bonding, thereby causing an attracting force between the hydroxyl groups. The attracting force seems to allow bonding between the bonding film-formed base member 1 and the opposing base plate 4.

Depending on a temperature condition or the like, the hydroxyl groups attracting each other by the hydrogen bonding are disconnected from the surfaces, along with dehydration condensation. As a result, the bonds bound to the hydrogen groups are bound to each other on a contact interface between the bonding film-formed base member 1 and the opposing base plate 4. This seems to more strongly bond the base member 1 and the opposing base plate 4 to each other.

An activated condition on the surface of the bonding film 3 activated at step 2 is mitigated over time. Thus, preferably, step 3 is performed as immediately as possible after completion of step 2. Specifically, step 3 is performed, preferably, within 60 minutes after step 2, and more preferably within five minutes after that. The surface of the bonding film 3 maintains a sufficiently activated condition for the preferred time. Accordingly, at the present step, there can be obtained a sufficient bonding strength between the bonding film-formed base member 1 (the bonding film 3) and the opposing base plate 4 that are bonded to each other.

In other words, the bonding film 3 before being activated is a film formed by drying and burning a metal complex-containing liquid material and includes a metal atom and the leaving group 303 made of an organic component. Thus, the bonding film is relatively chemically stable and highly weather-resistant, allowing the bonding film to be suitable for long-term preservation. Accordingly, from a viewpoint of production efficiency of the bonded structure 5, it is effective to produce or purchase and preserve a large number of the base plates 2 with the bonding film 3 and apply energy to only necessary pieces of the base plates 2 with the bonding film 3 as described at step 2 immediately before bonding the film-formed base member 1 to the opposing base plate 4 at step 3.

In the manner described above, the bonded structure (the bonded structure of the embodiment) 5 can be obtained shown in FIG. 2D.

In FIG. 2D, the opposing base plate 4 and the bonding film-formed base member 1 are laminated together such that the opposing base plate 4 covers an entire surface of the bonding film 3 contacted with the opposing base plate 4. However, alternatively, a relative position of the opposing base plate 4 with respect to the bonding film 3 may be deviated. For example, the bonding film-formed base member 1 and the opposing base plate 4 may be placed one on top of the other such that the opposing base plate 4 is protruded from an edge of the bonding film 3.

In the bonded structure 5 thus formed, the bonding strength between the base plate 2 and the opposing base plate 4 is preferably equal to or higher than 5 MPa (50 kgf/cm²), and more preferably equal to or higher than 10 MPa (100 kgf/cm²). The bonded structure 5 having the above bonding strength enables separation between the base plates 2 and 4 to be sufficiently prevented. As will be described later, for example, when a liquid droplet discharging head is formed by using the bonded structure 5, the discharging head can have high durability. In addition, using the bonding film-formed base member 1 of the embodiment allows efficient formation of the bonded structure 5 in which the base plate 2 is bonded to the opposing base plate 4 with the large bonding strength as above.

In the conventional solid-to-solid bonding method for directly bonding silicon base plates together, activation condition of surfaces of the base plates is maintained only for a extremely short time, such as a few to a few tens of seconds, in the air. Accordingly, after activation of the surfaces, it is difficult to sufficiently secure a time for work such as bonding between the two base plates as objects to be bonded together.

In contrast, in the embodiment, the activation condition can be maintained for a relatively long time. Thus, a sufficient bonding time is available, whereby bonding efficiency can be improved. The relatively long-time maintainability for the activation condition seems to be a result of stabilization of the activation condition obtained by elimination of the organic leaving group 303.

During or after formation of the bonded structure 5, as a step for increasing the bonding strength of the structure 5, at least one of following three steps (4A, 4B, and 4C) may be performed on the bonded structure 5 (a laminate including the bonding film-formed base member 1 and the opposing base plate 4) according to need. This can lead to a further increase in the bonding strength of the bonded structure 5.

At step 4A, as shown in FIG. 2E, the obtained bonded structure 5 is pressurized in a direction in which the base plate 2 and the opposing base plate 4 come close to each other.

Thereby, respective surfaces of the base plates 2 and 4 facing respective surfaces of the bonding film 3 more closely contact with the surfaces of the bonding film 3, so as to further increase the bonding strength of the bonded structure 5.

In addition, with pressurization of the bonded structure 5, any space between bonded interfaces in the bonded structure 5 can be crushed to further increase a bonding area, resulting in a further improvement in the bonding strength of the bonded structure 5.

A preferable pressure applied to the bonded structure 5 is as high as possible within a range not causing any damage to the bonded structure 5. This can increase the bonding strength of the bonded structure 5 in proportion to a pressure applied.

The pressure may be appropriately adjusted in accordance with conditions such as the material of each of the base plate 2 and the opposing base plate 4, a thickness of each thereof, and a bonding device. Specifically, the pressure is preferably approximately 0.2 to 15 MPa and more preferably approximately 5 to 10 MPa, although the preferable pressure range varies to some extent depending on the material of, the thickness of, and the like of the base plate 2 and the opposing base plate 4. Thereby, the bonding strength of the bonded structure 5 can be surely increased. The pressure to be applied may exceed an upper limit value of the above range, although damage or the like may be caused to the base plate 2 and the opposing base plate 4 depending on the material of each of the base plates 2 and 4.

A pressurization time is not specifically restricted, but is preferably approximately 10 seconds to 30 minutes. The pressurization time may be appropriately changed in accordance with a pressure to be applied. Specifically, even when the pressurization time is reduced as the pressure to the bonded structure 5 is increased, the bonding strength of the structure 5 can be improved.

At step 4B, as shown in FIG. 2E, the obtained bonded structure 5 is heated.

Heating the structure 5 can further increase the bonding strength.

A temperature for heating the bonded structure 5 is not restricted to a specific value as long as it is higher than room temperature and lower than a heat resistance temperature of the bonded structure 5. The heating temperature is preferably approximately 25 to 200° C. and more preferably approximately 70 to 150° C. Heating the bonded structure 5 within the above range can ensure that heat-induced degeneration or deterioration of the structure 5 can be prevented and the bonding strength can be increased.

A heating time is not specifically restricted, but is preferably approximately 1 to 30 minutes.

When performing both steps 4A and 4B, these steps are preferably simultaneously performed. In short, as shown in FIG. 2E, the bonded structure 5 is heated while being heated. This allows pressurization effect and heating effect to be synergistically exhibited, which particularly can increase the bonding strength of the bonded structure 5.

Then, at step 4C, as shown in FIG. 2F, UV light is applied to the obtained bonded structure 5.

This can increase chemical bonding formed between the bonding film and the base plates 2 and 4, respectively, thereby increasing the bonding strength between the bonding film 3 and each of the base plate 2 and the opposing base plate 4. As a result, the bonding strength of the bonded structure 5 can be significantly increased.

Conditions for applying UV light may be the same as those for the UV light described at step 2 above.

In addition, when performing the present step 4C, either one of the base plate 2 and the opposing base plate 4 needs to be translucent. Applying UV light through the translucent base plate allows the UV light to be surely applied to the bonding film 3.

Throughout those steps above, the bonding strength of the bonded structure 5 can be further increased easily.

As described above, the bonding film-formed base member of the embodiment is characterized by the composition of the bonding film 3. Hereinafter, the bonding film 3 will be described in detail.

As described above, the bonding film 3 is obtained by drying and burning a liquid material containing a metal complex and includes a metal atom and the leaving group 303 made of an organic component, as shown in FIGS. 3 and 4. When energy is applied to the bonding film 3, the leaving group 303 leaves at least from near the surface 35 of the bonding film 3. Then, as shown in FIG. 4, the active bond 304 occurs at least near the surface 35 of the bonding film 3, resulting in the occurrence of adhesion on the surface of the bonding film 3. With the occurrence of the adhesion, the bonding film-formed base member 1 can be strongly and efficiently boned to the opposing base plate 4 with high precision.

In addition, the bonding film 3 is a hardly-deformable, strong film, since the film 3, which is formed by drying and burning the metal complex-containing liquid, is an organic metal film including a metal atom and the organic leaving group 303. Accordingly, the bonding film 3 itself has a high size precision, so that the bonded structure 5 as a final product can also be obtained with high size precision.

The bonding film 3 is a solid having no fluidity. Thus, as compared to conventionally-known liquid or paste (semi-solid) adhesives having fluidity, there are almost no changes in the thickness and shape of the bonding film 3. Accordingly, the size precision of the bonded structure 5 obtained using the bonding film-formed base member 1 is much higher than that in the conventional method. Furthermore, adhesive-curing time is unnecessary and thus a strong bonding can be achieved in a short time.

In the embodiment, preferably, the bonding film 3 exhibits conductivity, so that the bonding film 3 can be applied to a wiring, a terminal, or the like provided on a wiring board in a bonded structure described below.

In order to allow the bonding film 3 as above to favorably serve, the metal atom and the leaving 303 are selected as below.

Specifically, examples of the metal atom include transition metallic elements such as Sc, Ti, V, Cr, Mn, Fe, Co, Ni, Cu, Y, Zr, Nb Mo, Tc, Ru, Rh, Pd, Ag, Hf, Ta, W, Re, Os, Ir, Pt, Au, lanthanoid elements, and actinoid elements, and main group metallic elements such as Li, Be, Na, Mg, Al, K, Ca, Zn, Ga, Rb, Sr, Cd, In, Sn, Sb, Cs, Ba, Tl, Pd, Bi, and Po.

The transition metallic elements have similar physical properties, since the elements are different only in a number of an eternal-shell electron. In general, the transition metals are high in hardness and boiling point and excellent in electric and thermal conductivities. Accordingly, when using a transition metallic element as the metal atom included in the bonding film 3, the adhesion occurring in the bonding film 3 can be further increased, as well as the bonding film 3 can have higher conductivity.

When the metal atom is one kind or a combination of two or more kinds selected from Cu, Al, Zn, Fe, and Ru, the bonding film 3 exhibits excellent conductivity. In addition, when the metal complex-containing liquid is dried and burned to form the bonding film 3, a raw material made of a metal complex including any of the materials above can be used to relatively easily form the bonding film 3 having an even thickness.

As described above, elimination of the leaving group 303 from the bonding film 3 allows generation of the active bond in the bonding film 3. Accordingly, the leaving group 303 to be suitably selected is a group that is relatively easily and evenly eliminated by application of energy, while being surely bound to the bonding film 3 without being detached when no energy is applied.

Specifically, suitable examples of the leaving group 303 include an atomic group including a carbon atom as an essential element and at least one kind selected from the group comprising a hydrogen atom, a nitrogen atom, an oxygen atom, a phosphorus atom, a sulfur atom, and a halogen atom. Using the leaving group 303 as mentioned above is relatively advantageous in terms of selection of bonding or elimination by application of energy. Therefore, the leaving group 303 as above can sufficiently meet the requirement mentioned above, thereby further increasing the adhesion of the bonding film-formed base member 1.

More specifically, for example, the atomic group may be an alkyl group such as a methyl group or an ethyl group, an alkoxy group such as a methoxy group or an ethoxy group, a carboxyl group, or the alkyl group having an isocyanate group, an amino group, a sulfonic acid group, or the like bound at an end thereof.

Among the atomic groups, particularly, the leaving group 303 preferably includes an alkyl group. Since the leaving group 303 including an alkyl group has high chemical stability, the bonding film 3 including an alkyl group as the leaving group 303 exhibits excellent weather resistance and chemical resistance.

In the bonding film 3 thus structured, a ratio of the metal atom to the carbon atom is preferably approximately 3:7 to 7:3, and more preferably approximately 4:6 to 6:4. Setting the ratio between the metal atom and the carbon atom within the above range can increase stability of the bonding film 3, thereby enabling the bonding film-formed base member 1 and the opposing base plate 4 to be more strongly bonded together. In addition, the bonding film 3 can exhibit excellent conductivity.

The bonding film has an average thickness of preferably approximately 1 to 1000 nm and more preferably approximately 50 to 800 nm. Setting the average thickness of the bonding film 3 within the above range can prevent significant reduction in the size precision of the bonded structure 5 obtained by bonding the base member 1 to the opposing base plate 4, while increasing the bonding strength between the base member 1 and the opposing base plate 4.

In other words, if the average thickness of the bonding film 3 is below a lower limit value of the range, a sufficient bonding strength cannot be obtained. Meanwhile, when the bonding film 3 has an average thickness exceeding an upper limit value of the range, the size precision of the bonded structure 5 may be significantly reduced.

The bonding film 3 having an average thickness within the range can have high shape followability to some extent. Accordingly, for example, even if the bonding surface of the base plate 2 (the surface facing the bonding film 3) has an uneven portion, the bonding film 3 can be adhered so as to cover the bonding surface while following along a shape of the uneven portion, although the shape followability depends on a height of the uneven portion. As a result, the bonding film 3 is provided so as to absorb the uneven portion, thereby mitigating the height of an uneven portion occurring on the surface of the film. Then, when the bonding film-formed base member 1 is bonded to the opposing base plate 4, adhesion of the bonding film 3 to the opposing base plate 4 can be increased.

A degree of the shape follow ability as mentioned above becomes more apparent as the thickness of the bonding film 3 is increased. Thus, in order to secure sufficient shaper followability, the thickness of the bonding film 2 may be made as large as possible.

In the embodiment, the bonding film 3 provided on the base plate 2 as described above is formed by drying and burning a metal complex-containing liquid material supplied on the base plate 2.

Next will be described a method for forming the bonding film 3 using the metal complex-containing liquid material.

At step 1, first, the base plate 2 is prepared.

The base plate 2 may be a base plate subjected to a surface treatment, or may have an intermediate layer formed on a surface thereof.

Then, at step 2, a metal complex-containing liquid material is supplied on the base plate 2. After removing a solvent in the liquid material, the material is dried to form a dry coating film on the base plate 2.

A method for supplying the liquid material on the base plate 2 is not restricted to a specific one. There may be mentioned various methods for supplying the liquid, such as spin coating, casting, micro gravure coating, gravure coating, bar coating, roll coating, wire-bar coating, dip coating, spray coating, screen printing, flexographic printing, offset printing, microcontact printing, and a liquid droplet discharging method.

The liquid material usually has a viscosity (at 25° C.) ranging preferably approximately from 0.5 to 200 mPa·s, and more preferably approximately 3 to 100 mPa·s. Setting the viscosity of the liquid material within the above range can ensure that the liquid material is supplied on the base plate 2. In addition, when the liquid material is dried and burned, the liquid material can contain a sufficient amount of a metal complex to form the bonding film 3.

Among the liquid supplying methods, the liquid droplet discharging method is particularly preferable. The liquid droplet discharging method can discharge droplets of the liquid material on the surface of the base plate 2. Thus, even when the liquid material is selectively supplied on a partial region of the base plate 2, the discharging method can surely supply the liquid in a manner corresponding to a shape of the region.

Although the liquid droplet discharging method is not restricted to a specific one, an inkjet method is suitably used to discharge a liquid material by using piezoelectric-element-induced vibration. Using the inkjet method allows droplets of the liquid material to be supplied with a high positional precision on an intended region (position). In addition, appropriately setting a number of vibrations of piezoelectric elements, a viscosity of the liquid material, and the like allows a droplet size to be relatively easily adjusted. Thus, even if the region for forming the bonding film 3 has a minute shape, the liquid material can be supplied as small droplets so as to correspond to the shape of the region.

When using the liquid droplet discharging method to supply the liquid material, the liquid material has a viscosity (at 25° C.) ranging preferably approximately from 3 to 10 mPa·s and more preferably approximately from 4 to 8 mPa·s. Setting the viscosity of the liquid material within the above range allows stable discharging of liquid droplets, as well as allows discharging of droplets having a size enough to draw a shape corresponding to the minute-shaped region for forming the bonding film 3.

When the viscosity of the liquid material is set within the range, specifically, an amount of a liquid droplet 31 (an amount of a single droplet of the liquid material) can be set to approximately 0.1 to 40 pL on average, and more practically to approximately 1 to 30 pL on average. This allows a diameter of a droplet landing on the base plate 2 to be small, so that the bonding film 3 having a minute shape can also be surely formed.

Furthermore, setting appropriately the amount of the liquid droplet 31 supplied on the base plate 2 allows the thickness of the bonding film 3 formed to be relatively easily controlled.

The liquid material includes a metal complex as mentioned above and a solvent or a dispersion medium used to dissolve or disperse the metal complex in a material.

The solvent or the dispersion medium for dissolving or dispersing the metal complex is not specifically restricted. Examples of the solvent or the dispersion medium include inorganic solvents such as ammonia, water, hydrogen peroxide, carbon tetrachloride, and ethylene carbonate, ketone solvents such as methyl ethyl ketone (MEK) and acetone, alcoholic solvents such as methanol, ethanol, and isobutanol, ether solvents such as diethyl ether and diisopropyl ether, amine solvents such as butylamine and dodecylamine, cellosolve solvents such as methyl cellosolve, aliphatic hydrocarbon solvents such as hexane and pentane, aromatic hydrocarbon solvents such as toluene, xylene, and benzene, aromatic heterocyclic solvents such as pyridine, pyrazine, and furan, amido solvents such as N,N-dimethylformamide (DMF), halogen solvents such as dichloromethane and chloroform, ester solvents such as ethyl acetate and methyl acetate, sulfuric solvents such as dimethyl sulfoxide (DMSO) and sulfolane, nitrile solvents such as acetonitrile, propionitrile, and acrylonitrile, various organic solvents such as organic acid solvents including formic acid and trifluoroacetic acid, and mixtures of any of the solvents mentioned above.

The metal complex, which is contained in the liquid material, is a main material of a dry coating film formed by drying the liquid material.

The metal complex is appropriately selected in accordance with the kind of the bonding film 3 to be formed and is not specifically restricted. For example, the metal complex may be beta-diketone complexes such as bis(2,6-dimethyl-2-trimethylsilyloxy)-3,5-heptadionato)copper (II) (Cu(SOPD)₂; C₂₄H₄₆CuO₆Si₂), 2,4-pentadionato-copper (II), Cu(hexyafluoro acetylacetonate) (vinyl trimethyl silane) [Cu(hfac) (VTMS)], Cu(hexyafluoro acetylacetqnate) (2-methyl-1-hexene-3-ene), [Cu(hfac) (MHY)], Cu(perfluoro acetyl acetonate) (vinyl trimethyl silane) [Cu(pfac) (VTMS)], Cu(perfluoro acetyl acetonate) (2-methyl-1-hexene-3-ene), [Cu(pfac) (MHY)], bis(dipivaloylmethanate)copper [Cu(DPM)₂, DMP:C₁₁H_{19O}₂], tris(dipivaloylmethanate)iridium [Ir(DPM)₃], tris(dipivaloylmethanate)yttrium [Y (DPM)₃], tris(dipivaloylmethanate)gadolinium [Gd(DPM)₃], bis(isobutyl pivaloylmethanate)copper [Cu(IBPM)₂, IBMP:C₁₀H₁₇O₂]tris(isobutyl pivaloylmethanate)ruthenium [Ru(IBPM)₃], bis(diisobutyryl methanate)copper [Cu(DIBM)₂, DIBM:C₉H₁₅O₂]; quinolinol complexes such as tris(8-quinolinolato)aluminum (Alq₃), tris(4-methyl-8-quinolinolate)aluminum (III) (Almq₃), and (8-hydroxynoline)zinc (Znq₂); phthalocyanine complexes such as copper phthalocyanine; carboxylic acid complexes such as copper trifluoroacetate, yittrium trifluoroacetate, and copper terephthalate; copper formate complexes expressed by a following chemical formula (1), or the like. Among them, beta-diketone complexes are preferably used. Many of beta-diketone complexes show a relatively high solubility to various kinds of solvents. Thus, a combination of any of the beta-diketone complexes and any of the solvents as mentioned above may be appropriately selected, whereby a sufficient amount of the selected beta-diketone complex can be dissolved in the selected solvent to form the bonding film 3 having an intended film thickness.

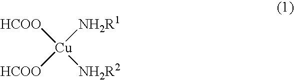

In the chemical formula (1), Cu represents a divalent copper, and R¹ and R² each represent an aliphatic hydrocarbon group that may have a substituent.

The aliphatic hydrocarbon group represented by R¹ and R² in the formula may be saturated or unsaturated.

The saturated aliphatic hydrocarbon group may be an alkyl group. Examples of the alkyl group include straight-chain alkyl groups such as a butyl group, a hexyl group, an octyl group, a decyl group, a dodecyl group, a hexadecyl group, and a nonadecyl group, and branched alkyl groups such as an isobutyl group, a 1-metylhexyl group, a 1-methyloctyl group, a 1-methyldecyl group, 1-methyldodecyl group, a 1-ethyldodecyl group, a 1-methylhexadecyl group, a 1-metylnonadecyl group, a tert-butyl group, a 1,1-dimethylhexyl group, a 1,1-dimethyloctyl group, a 1,1-dimethyldecyl group, a 1,1-dimethyldodecyl group, a 1,1-dimethylhexadecyl group, and a 1,1-dimethylnonadecyl group.

The unsaturated aliphatic hydrocarbon group may be an alkenyl group or an alkynyl group. Examples of the alkenyl group include straight-chain alkenyl groups such as a 1-butenyl group, a 1-hexenyl group, a 1-octenyl group, a 1-decenyl group, a 1-dodecenyl group, a 1-hexadeceyl group, and a 1-nonadecenyl group, and branched alkenyl groups such as an isobutyl group, a 1-methyl-1-hexenyl group, a 1-methyl-1-octenyl group, a 1-methyl-1-decenyl group, a 1-methyl-1-dodecenyl group, a 1-methyl-1-hexadecenyl group, a sec-butenyl group, a 1,1-dimethyl-2-hexenyl group, a 1,1-dimethyl-3-octenyl group, a 1,1-dimethyl-4-decenyl group, a 1,1-dimethyl-5-dodecenyl group, and a 1,1-dimethyl-6-hexadecenyl group.

Examples of the alkynyl group include straight-chain alkynyl groups such as a 2-butynyl group, a 2-hexynyl group, a 2-octynyl group, a 2-decynyl group, a 2-dodecynyl group, a 2-hexadecynyl group, and a 2-nonadecynyl group, and branched alkynyl groups such as an isobutyl group, a 1-methyl-2-hexynyl group, a 1-methyl-2-octynyl group, a 1-methyl-2-decynyl group, a 1-methyl-2-dodecynyl group, a 1-methyl-2-hexadecynyl group, a 1,1-dimethyl-2-hexynyl group, a 1,1-dimethyl-3-octyl group, a 1,1-dimethyl-4-decynyl group, a 1,1-dimethyl-5-dodecynyl group, and a 1,1-dimethyl-6-hexadecynyl group.

In formation of the bonding film 3 by burning the dry coating film at step 3 below, using any of the metal complexes as above allows removal (elimination) of an organic substance included in the metal complex therefrom, while allowing a part of the organic substance to remain in the bonding film 3.

A temperature for drying the liquid material varies slightly depending on kinds of the metal complex and the solvent or the dispersion medium included in the liquid material. The drying temperature is preferably approximately 25 to 100° C. and more preferably approximately 25 to 75° C.

A time for drying the liquid material is preferably approximately 0.5 to 48 hours and more preferably approximately 15 to 30 hours.

In addition, the liquid material may be dried under atmospheric pressure but is more preferably dried under reduced pressure. In the case of reduced pressure, a preferable reduced pressure range is approximately from 1×10 ⁻⁷ to 1×10⁻⁴ Torr, and a more preferable reduced pressure range is approximately from 1×10⁻⁶ to 1×10⁻⁵ Torr:

Setting the conditions for drying the liquid material within the ranges as above can ensure that the solvent or the dispersion medium is removed from the liquid material to form the dry coating film mainly made of the metal complex on the base plate 2.

Next, at step 3, the dry coating film formed on the base plate 2 is burned.

Thereby, the organic substance included in the metal complex of the dry coating film is removed from the metal complex while a part of the organic substance remains in the film. Consequently, on the base plate 2 is formed the bonding film 3 including the metal atom and the leaving group made of the organic component.

In the method for forming the bonding film 3 by burning the dry coating film including the metal complex as above, when the dry coating film is burned, the a part of the organic substance remaining in the bonding film 3 acts as the leaving group 303. That is, the present embodiment uses, as the leaving group 303, the a part of the organic substance (a remnant) remaining in the bonding film 3 in formation of the film. Thus, no leaving group needs to be introduced in the formed metal film or the like, so that.the bonding film 3 can be formed by a relatively simple process including drying and burning of the metal complex-containing liquid material.

Additionally, all or some of the a part of the organic substance remaining in the bonding film 3 formed using the metal complex may act as the leaving group 303.

A temperature for burning the dry coating film varies slightly depending on the kind of the metal complex. A preferable burning temperature is approximately 70 to 300° C. and a more preferable temperature is approximately 100 to 150° C.

A time for burning the dry coating film is preferably approximately 0.5 to 48 hours and more preferably approximately 15 to 30 hours.

Burning the dry coating film under the above conditions allows the organic substance included in the metal complex to be surely removed therefrom while allowing the a part of the organic substance to remain in the film. This can ensure that the bonding film 3 formed exhibits suitably adhesion by energy applied to the surface of the film.

An ambient pressure during the burning of the dry coating film may be atmospheric pressure but is more preferably reduced pressure. In the atmosphere of reduced pressure, a reduced pressure range is preferably approximately from 1×10⁻⁷ to 1×10⁻⁴ Torr, and more preferably approximately from 1×10⁻⁶ to 1×10⁻⁵ Torr. Thereby, a film density of the bonding film 3 is increased, allowing the bonding film 3 to have more improved film strength.

An atmosphere during the burning of the dry coating film is not restricted to a specific one, but is preferably an atmosphere containing an inert gas such as nitrogen, argon, or helium. Thereby, the bonding film 3 can be formed while allowing the a part of the organic substance in the metal complex to remain without removing almost all the organic substance included in the metal complex, namely without forming a pure metal film on the base plate 2. As a result, the bonding film 3 formed can exhibit excellent properties to serve both as a bonding film and a metal film.

When the metal complex contains an oxygen atom in its molecular structure, as in 2,4-pentadionato-copper (II) or [Cu(hfac) (VTMS)], preferably, hydrogen gas is added to the atmosphere. This can improve reductivity with respect to the oxygen atom, whereby the bonding film 3 can be formed without allowing the oxygen atom to be excessively left in the bonding film 3. Consequently, the bonding film 3 has a low rate of a metal oxide therein and thus exhibits excellent conductivity.

Furthermore, as described above, the bonding film 3 is formed while the a part of the organic substance in the metal complex of the dry coating film remains. Due to the presence of the organic substance remaining, the bonding film 3 becomes relatively flexible. Accordingly, when the base plate 2 and the opposing base plate 4 are bonded together via the bonding film 3 as shown in FIG. 2D to form the bonded structure 5, stress caused by thermal expansion between the base plates 2 and 4 can be surely mitigated even if the materials of the base plates 2 and 4 are different. As a result, in the bonded structure 5 finally obtained, separation between the base members can be surely prevented.

Still furthermore, since the metal complex has a relatively high chemical resistance, the bonding film 3 formed by using the metal complex can be effectively used to bond a constituent member exposed to chemical products or the like for a long period of time. Specifically, for example, when producing a liquid droplet discharging head for an industrial inkjet printer using organic ink that tends to easily erode resin, using the bonding film 3 of the embodiment can improve durability of the discharging head. In addition, the metal complex is highly heat resistant. Thus, using the bonding film 3 including the metal complex can advantageously used to bond together constituent members exposed to high temperature.

In this manner, the bonding film 3 is formed on the base plate 2 to obtain the bonding film-formed base member 1.

The present embodiment has described the method for forming the bonding film-formed base member by using the inkjet method as the liquid droplet discharging method. However, the liquid droplet discharging method is not restricted to that and may be a bubble jet method (“bubble jet” is a registered trademark) using thermal expansion of a material by an electrothermal converting element to discharge ink. The bubble jet method can have the same advantageous effects as those described in the inkjet method.

### Second Embodiment

Next will be described a bonding film-formed base member according to a second embodiment, a method for bonding the bonding film-formed base member to an opposing base plate according to a second embodiment (a bonding method of the second embodiment), and a bonded structure including the bonding film-formed base member according to a second embodiment.

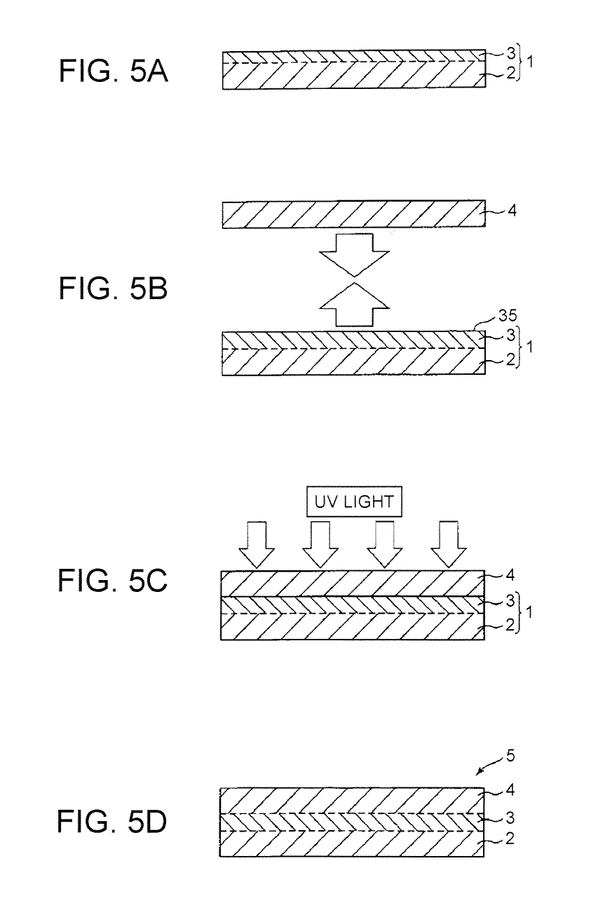

FIGS. 5A to 5D are longitudinal sectional views for illustrating the bonding method of the second embodiment using the bonding film-formed base member of the first embodiment. In the description below, upper and lower sides, respectively, in FIGS. 5A to 5D, will be referred to as “upper” and “lower”, respectively.

Hereinafter, the bonding method of the second embodiment will be described. The description will focus on points different from those in the bonding method of the first embodiment, without repeating the same points as in the first embodiment.

The bonding method of the second embodiment is the same as that of the first embodiment excepting that energy is applied to the bonding film 3 after the bonding film-formed base member 1 and the opposing base plate 4 are laminated together.

Specifically, the bonding method of the second embodiment includes preparing the bonding film-formed base member 1 of the embodiment; preparing the opposing base plate (the object to be bonded together) 4 to laminate the bonding film-formed base member 1 and the opposing base plate 4 together such that the bonding film 3 of the base member 1 closely adheres to the opposing base plate 4; and applying energy to the bonding film 3 in a laminate formed by laminating the base member 1 and the opposing base plate 4 together to activate the bonding film 3 so as to obtain the bonded structure 5 including the bonding film-formed base member 1 and the opposing base plate 4 bonded together.

Hereinafter, steps of the bonding method of the second embodiment will be described in a sequential order of the steps.

First, at step 1, similarly to the first embodiment, the bonding film-formed base member 1 is prepared (See FIG. 5A).

Next, at step 2, as shown in FIG. 5B, the opposing base plate 4 is prepared, and the bonding film-formed base member 1 and the opposing base plate 4 are laminated together such that the surface 35 of the bonding film 3 closely contacts with a surface of the opposing base plate 4, so as to obtain the laminate. In the condition where the laminate is obtained, the base member 1 and the opposing base plate 4 are not bonded to each other yet. Accordingly, a position of the base member 1 relative to the opposing base plate 4 can be adjusted. Accordingly, after the base member 1 and the opposing base plate 4 are laminated together, fine adjustments of the relative positions between the base member 1 and the opposing base plate 4 can be easily performed. This can improve positional precision in a direction of the surface 35 of the bonding film 3.

Next, at step 3, as shown in FIG. 5C, energy is applied to the bonding film 3 in the laminate. With the energy application to the bonding film 3, the bonding film 3 obtains adhesion to the opposing base plate 4. Consequently, the bonding film-formed base member 1 is bonded to the opposing base plate 4 to obtain the bonded structure, as shown in FIG. 5D.

The energy application to the bonding film 3 can be performed by any method, such as any of the methods mentioned in the first embodiment.

In the second embodiment, when applying energy to the bonding film 3, it is preferable to use at least one of following methods: application of an energy beam to the bonding film 3, heating of the bonding film 3, and application of a compressive force (physical energy) to the bonding film 3. Those methods are suitable in allowing energy to be relatively easily and efficiently applied to the bonding film 3.

The energy beam may be applied to the bonding film 3 in the same manner as in the first embodiment.

In this case, the energy beam is transmitted through the base plate 2 or the opposing base plate 4 to be applied to the bonding film 3. Accordingly, the base plate 2 or the opposing base plate 4, which is located in a direction from which the energy beam is applied, is made of a translucent material.

Meanwhile, when heating the bonding film 3 to apply energy to the film 3, a heating temperature is preferably approximately 25 to 200° C. and more preferably approximately 50 to 100° C. Heating the bonding film 3 within the range can surely prevent degeneration or deterioration of the base plates 2 and 4 due to heat and also can ensure activation of the bonding film 3.

A time for heating the bonding film 3 is not restricted as long as the heating time is set within a range allowing just elimination of the leaving group 303 of the bonding film 3. Specifically, when the heating temperature is within the above range, a preferable heating time range is approximately from 1 to 30 minutes.

The bonding film 3 can be heated by using any method, such as a heater, infrared ray irradiation, or contacting of the bonding film 3 with a flame.

In the infrared ray irradiation, preferably, the base plate 2 or the opposing base plate 4 is made of a light-absorbing material. Thereby, the base plate 2 or the opposing base plate 4, to which an infrared ray is applied, efficiently generates heat, resulting in efficient heating of the bonding film 3.

When the bonding film 3 is heated by a heater or by allowing the film to contact with a flame, the base plate 2 or the opposing base plate 4, which is intended to bring closer to the heater or to be contacted with the flame, is preferably made of a material excellent in thermal conductivity. In this manner, heat can be efficiently conducted to the bonding film 3 through the base plate 2 or the opposing base plate 4, thereby leading to efficient heating of the bonding film 3.

Meanwhile, when using a compressive force as energy applied to the bonding film 3, the bonding film 3 is compressed by a pressure of preferably approximately 0.2 to 10 MPa and more preferably approximately 1 to 5 MPa in a direction where the bonding film-formed base member 1 and the opposing base plate 4 come closer to each other. In this method, with the use of mere compression, appropriate energy can easily be applied to the bonding film 3, whereby the bonding film 3 exhibits a sufficient adhesion to the opposing base plate 4. Although the pressure may be larger than an upper limit value of the above range, damage or the like may be caused to the base plate 2 or the opposing base plate 4 depending on the material of each base plate.

A time for applying the compressive force is not restricted to a specific one, but is preferably approximately 10 seconds to 30 minutes. The compressing time may be appropriately changed in accordance with a magnitude of the compressive force. Specifically, the compressing time can be reduced as the compressive force is increased.

In the manner described above, the bonded structure 5 can be obtained.

### Third Embodiment

Next will be described a bonding film-formed base member according to a third embodiment, a method for bonding the bonding film-formed base member to an opposing base plate according to a third embodiment (a bonding method of the third embodiment), and a bonded structure including the bonding film-formed base member according to a third embodiment.

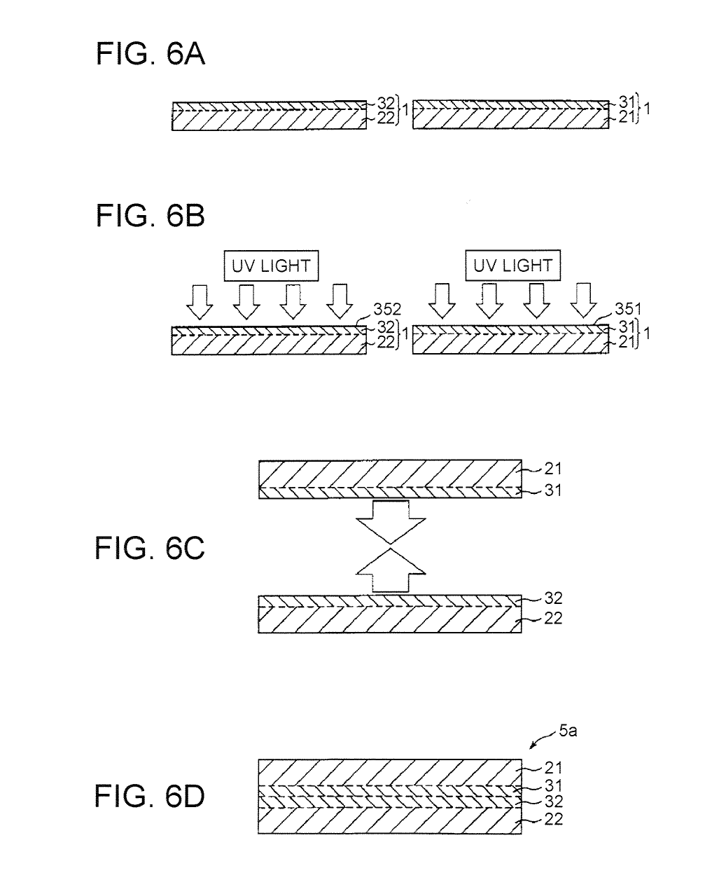

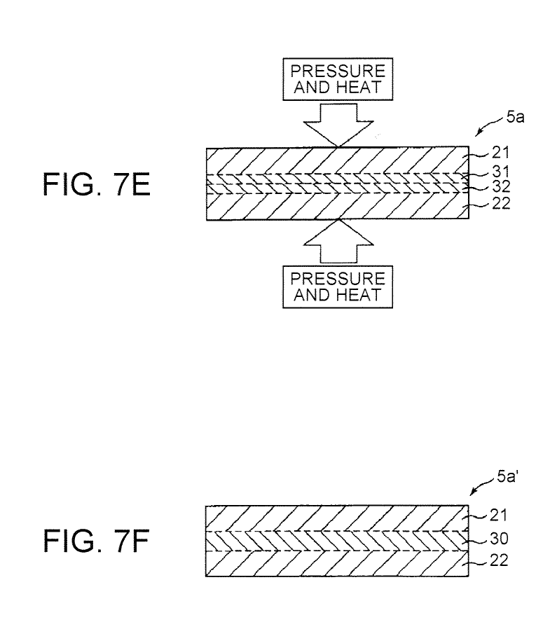

FIGS. 6A to 7F are longitudinal sectional views for illustrating the bonding method of the third embodiment using two bonding film-formed base members, each of which is same as that of the first embodiment. In the description below, upper and lower sides, respectively, in FIGS. 6A to 7F, will be referred to as “upper” and “lower”, respectively.

Hereinafter, the bonding method of the third embodiment will be described. The description will focus on points different from the first and the second embodiments, without repeating the same points as in the embodiments.

The bonding method of the third embodiment is the same as that of the first embodiment, except for bonding together two bonding film-formed base members 1, each of which is the same as that of the first embodiment.

Specifically, the bonding method of the third embodiment includes preparing the two bonding film-formed base members 1 same as that of the first embodiment; applying energy to respective bonding films 31 and 32 of the two bonding film-formed base members 1 to activate the bonding films 31 and 32; and bonding the two bonding film-formed base members 1 together such that the bonding films 31 and 32 closely adhere to each other so as to obtain a bonded structure 5a.

Hereinafter, steps of the bonding method of the third embodiment will be described in a sequential order of the steps.

First, at step 1, similarly to the first embodiment, the two bonding film-formed base members 1 are prepared (See FIG. 6A). In the present embodiment, the two bonding film-formed base members 1 prepared includes a bonding film-formed base member 1 with a base plate 21 and the bonding film 31 formed on the base plate 21 and a bonding film-formed base member 1 with a base plate 22 and the bonding film 32 formed on the base plate 22, as shown in FIG. 6A.

Next, at step 2, as shown in FIG. 6B, energy is applied to the respective bonding films 31 and 32 of the two base members 1. With energy applied to the bonding films 31 and 32, the leaving group 303 shown in FIG. 3 is eliminated from each of the bonding films 31 and 32. After elimination of the leaving group 303, as shown in FIG. 4, the active bond 304 occurs near the surface 35 of each of the bonding films 31 and 32 to activate the films. As a result, the bonding films 31 and 32 each have adhesion.

The two bonding film-formed base members 1 in the above condition can be adhesive to each other.

The energy application can be performed in the same manner as in the first embodiment.

In that case, as described in the first embodiment, the condition where the bonding films 31 and 32 are “activated” means the condition where the leaving group 303 on the surface 35 of and in an inside of each bonding film is eliminated and thereby a non-terminated bond (a “broken bond” or a “dangling bond”) occurs in the atomic structure of the bonding film; the condition where the broken bond has a hydroxyl group (an OH group) at an end thereof; and the condition where the above two conditions occur together.

Accordingly, in the present specification, the active bond 304 is referred to as a broken bond (a dangling bond) or a broken bond having a OH group at an end thereof, as shown in FIG. 4.

Next, at step 3, as shown in FIG. 6C, the two bonding film-formed base members 1 are bonded together such that the adhesive bonding films 31 and 32 closely adhere to each other, thereby obtaining the bonded structure 5a.

At the present step, the two base members 1 are bonded to each other. The bonding seems to be achieved based on at least one of two mechanisms (i) and (ii) as follows:

(i) For example, OH groups are exposed on respective surfaces 351 and 352 of the respective bonding films 31 and 32. At the present step, when the two bonding film-formed base members 1 are bonded together such that the bonding films 31 and 32 closely adhere to each other, the OH groups present on the surfaces 351 and 352 of the bonding films 31 and 32 pull each other through hydrogen bonding, thereby generating a pulling force between the OH groups. The pulling force seems to serve to bond the two bonding film-formed base members 1 together.

In addition, the OH groups pulling each other through the hydrogen bonding are separated from the surfaces, along with dehydration condensation, depending on conditions such as temperature. Thereby, between the two bonding film-formed base members 1, bonding occurs between bonds from which the OH groups were disconnected. As a result, the two bonding film-formed base members 1 seem to be more strongly bonded together.

(ii) When the two bonding film-formed base members 1 are bonded together, re-bonding occurs between non-terminated bonds (broken bonds) generated near the surfaces 351 and 352 of the bonding films 31 and 32. The re-bonding occurs in such a complicated manner that the bonds overlap each other (the bonds are entangled with each other), thereby forming a bonded structure network at a bonded interface between the base members 1. This allows metal atoms or oxygen atoms of the bonding films 31 and 32 to be directly bonded together, causing integration between the bonding films 31 and 32.

As described above, the mechanisms (i) and (ii) serve to form the bonded structure 5a as shown in FIG. 6D.

After formation of the bonded structure 5a, at least one of the steps 4A to 4C of the first embodiment may be performed on the bonded structure 5a if necessary.

For example, as shown in FIG. 7E, simultaneous heating and pressurization of the bonded structure 5a allows the base plates 21 and 22 of the bonded structure 5a to come closer to each other. This promotes dehydration condensation of the OH groups and re-bonding between the broken bonds on the interface between the bonding films 31 and 32, leading to further integration between the bonding films 31 and 32. As a result, as shown in FIG. 7F, there can be obtained a bonded structure 5a′ having a bonding film 30 formed by almost completely integrating the bonding films 31 and 32 into each other.

### Fourth Embodiment

Next will be described a bonding film-formed base member according to a fourth embodiment, a method for bonding the bonding film-formed base member to an opposing base plate according to a fourth embodiment (a bonding method of the fourth embodiment), and a bonded structure including the bonding film-formed base member according to a fourth embodiment.

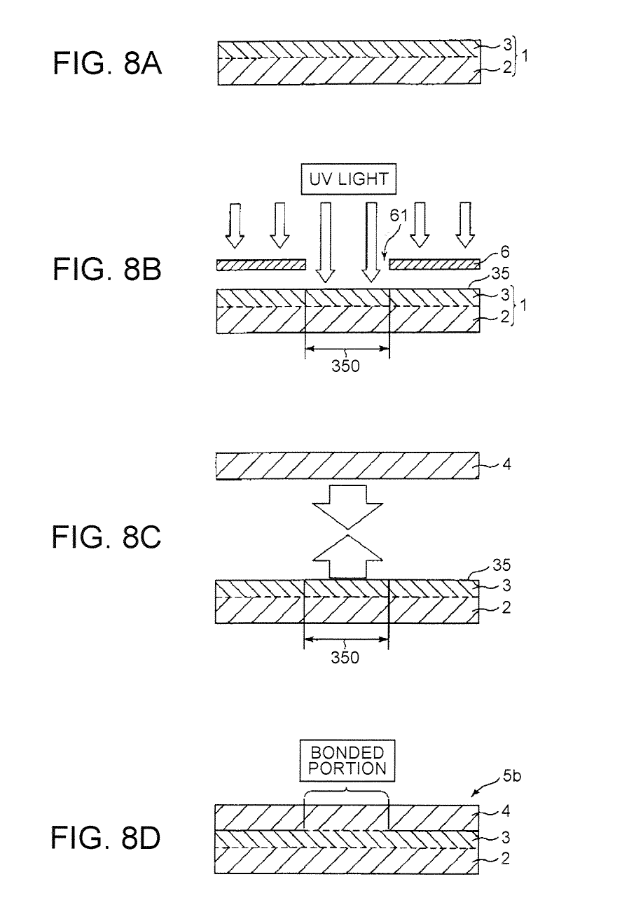

FIGS. 8A to 8D are longitudinal sectional views for illustrating the bonding method of the fourth embodiment using the bonding film-formed base member of the first embodiment. In the description below, upper and lower sides, respectively, in FIGS. 8A to 8D, will be referred to as “upper” and “lower”, respectively.

Hereinafter, the bonding method of the fourth embodiment will be described. The description will focus on points different from the first to the third embodiments, without repeating the same points as in the embodiments.

The bonding method of the fourth embodiment is the same as that of the first embodiment excepting that only a predetermined partial region 350 of the bonding film 3 is selectively activated to partially bonding the bonding film-formed base member 1 to the opposing base plate 4 at the predetermined region 350.

Specifically, the bonding method of the fourth embodiment includes preparing the bonding film-formed base member 1 of the first embodiment; applying energy selectively to the predetermined region 350 of the bonding film 3 included in the bonding film-formed base member 1 to selectively activate the predetermined region 350; preparing the opposing base plate (the object intended to be bonded together) 4 to bond the bonding film 3 of the bonding film-formed base member 1 to the opposing base plate 4 such that the bonding film 3 and the opposing base plate 4 closely adhere to each other, so as to obtain a bonded structure 5b formed by partially bonding the base member 1 to the opposing base plate 4 at the predetermined region 350.

Steps of the bonding method of the present embodiment will be described in a sequential order of the steps.

First, at step 1, similarly to the first embodiment, the bonding film-formed base member 1 (the bonding film-formed base member of the embodiment) is prepared (See FIG. 8A).

Next, at step 2, as shown in FIG. 8B, energy is applied selectively to the predetermined partial region 350 on the surface 35 of the bonding film 3 included in the bonding film-formed base member 1.

With the application of energy, on the predetermined region 350 of the bonding film 3, the leaving group 303 shown in FIG. 3 is eliminated from the bonding film 3. After elimination of the leaving group 303, in the predetermined region 350, the active bond 304 occurs near the surface 35 of the bonding film 3, thereby activating the bonding film 3. Consequently, the predetermined region 350 of the bonding film 3 becomes adhesive to the opposing base plate 4, whereas a region of the bonding film 3 excluding the predetermined region 350 dose not have any adhesion at all or hardly at all if any.

The bonding film-formed base member 1 in the above condition can be partially adhered to the opposing base plate 4 at the predetermined region 350 of the bonding film 3.

The energy applied to the bonding film 3 can be applied by any method, such as any of the methods mentioned in the first embodiment, for example.

In the present embodiment, a preferable method for applying energy to the bonding film 3 is energy beam irradiation. The energy beam irradiation is suitable to apply energy to the bonding film 3 relatively easily and efficiently.

Additionally, in the embodiment, in particular, the energy beam to be applied to the bonding film 3 is preferably a highly directional energy beam, such as a laser beam or an electron beam. Applying such an energy beam in an intended direction allows the energy beam to be applied selectively and easily to the predetermined region.

Even if the energy beam has a low directivity, the energy beam can be applied selectively to the predetermined region 350 by applying the energy beam while covering (concealing) the region excluding the predetermined region 350 to which the energy beam is to be applied on the surface 35 of the bonding film 3.

Specifically, as shown in FIG. 8B, above the surface 35 of the bonding film 3 is provided a mask 6 with a window 61. In order to apply the energy beam through the mask 6, the window 61 has a shape corresponding to a shape of the predetermined region 350 that is to be subjected to the energy beam irradiation. This allows selective application of the energy beam to the predetermined region 350.

Next, at step 3, as shown in FIG. 8C, the opposing base plate (the object intended to be bonded together) 4 is prepared. Then, the bonding film-formed base member 1 is bonded to the opposing base plate 4 such that the bonding film 3 having the selectively activated predetermined region 350 closely adheres to the opposing base plate 4, thereby obtaining the bonded structure 5b shown in FIG. 8D.

In the bonded structure 5b thus obtained, instead of bonding together opposing surfaces of the base plate 2 and the opposing base plate 4, only a partial region (the predetermined region 350) of the base plate 2 is bonded to a part of the opposing base plate 4 corresponding to the partial region. In the bonding, the region to be bonded can be easily selected merely by controlling the region of the bonding film 3 to which the energy is to be applied. In this manner, for example, bonding strength of the bonded structure 5b can be easily adjusted by controlling a size of the activated region (the predetermined region 350 in the present embodiment) on the bonding film 3 of the bonding film-formed base member 1. As a result, the bonded structure 5b can be obtained that allows bonded portions to be easily separated, for example.

In addition, local concentration of stress occurring at a bonded portion between the bonding film-formed base member 1 and the opposing base plate 4 shown in FIG. 8D, namely in the predetermined region 350, can be mitigated by appropriately controlling a size and a shape of the bonded portion (the predetermined region 350). Thereby, even if a thermal expansion coefficient is significantly different between the base plate 2 and the opposing base plate 4, the bonding film-formed base member 1 and the opposing base plate 4 can be surely bonded to each other.

Furthermore, between the bonding film-formed base member 1 and the opposing base plate 4 in the bonded structure 5b, a small space is present (remains) in the region excluding the predetermined region 350 bonded to the opposing base plate 4. Accordingly, adjusting the shape of the predetermined region 350 according to need can facilitate formation of a closed space, a flow channel, or the like between the bonding film-formed base member 1 and the opposing base plate 4.

Still furthermore, as described above, the bonding strength of the bonded structure 5b and a strength for disintegration of the bonded structure 5b (a splitting strength) can be adjusted by controlling the size of the bonded portion between the bonding film-formed base member 1 and the opposing base plate 4, namely the size of the predetermined region 350.

From the viewpoint as above, in order to form the bonded structure 5b that can be easily disintegrated, the bonding strength of the bonded structure 5b is preferably a strength that allows the bonded structure 5b to be easily disintegrated by hand. Thereby, the bonded structure 5b can be easily disintegrated without using any device or the like.

In that manner, the bonded structure 5b can be obtained.

After formation of the bonded structure 5b, at least one of the steps 4A to 4C of the first embodiment may be performed on the bonded structure 5b if necessary.

On the interface between the bonding film 3 and the opposing base plate 3 in the bonded structure 5b, the region (a non-bonded region) excluding the predetermined region 350 has a small space occurring (remaining) therein. Accordingly, preferably, the bonded structure 5b is simultaneously pressurized and heated performed under a condition in which the bonding film 3 is not bonded to the opposing base plate 4 in the region excluding the predetermined region 350.

Additionally, considering the description above, when performing at least one of the steps 4A to 4C of the first embodiment, the steps are preferably performed selectively to the predetermined region 350. This can prevent bonding between the bonding film 3 and the opposing base plate 4 in the region excluding the predetermined region 350.

### Fifth Embodiment

Next will be described a bonding film-formed base member according to a fifth embodiment, a method for bonding the bonding film-formed base member to an opposing base plate according to a fifth embodiment (a bonding method of the fifth embodiment), and a bonded structure including the bonding film-formed base member according to a fifth embodiment.

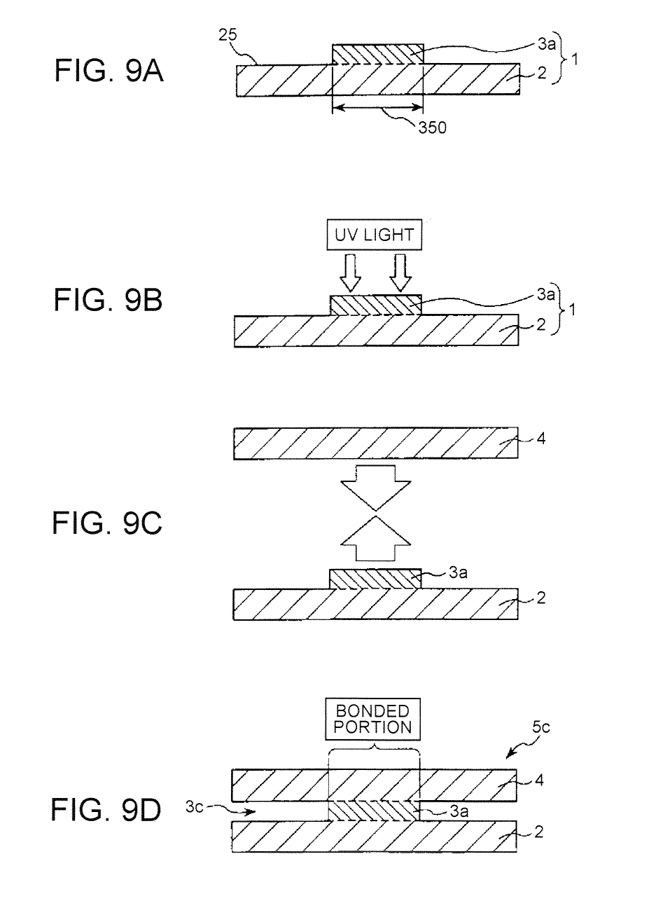

FIGS. 9A to 9D are longitudinal sectional views for illustrating the bonding method of the fifth embodiment using a bonding film-formed base member according to a modification of the first embodiment. In the description below, upper and lower sides, respectively, in FIGS. 9A to 9D, will be referred to as “upper” and “lower”, respectively.

Hereinafter, the bonding method of the fifth embodiment will be described. The description will focus on points different from the first to the fourth embodiments, without repeating the same points as in the embodiments.

The bonding method of the fifth embodiment is the same as that of the first embodiment excepting that a bonding film 3a is selectively formed only in the predetermined region 350 on an upper surface 25 of the base plate 2 to partially bond the bonding film-formed base member 1 to the opposing base plate 4 at the predetermined region 350.

Specifically, the bonding method of the fifth embodiment includes preparing the bonding film-formed base member 1 including the base plate 2 and the bonding film 3a formed only in the predetermined region 350 on the base plate 2; applying energy to the bonding film 3a of the bonding film-formed base member 1 to activate the bonding film 3a; and preparing the opposing base plate (the object intended to be bonded together) 4 to bond the opposing base plate 4 to the bonding film-formed base member 1 such that the bonding film 3a of the bonding film-formed base member 1 closely adheres to the opposing base plate 4, so as to obtain a bonded structure 5c formed by bonding the bonding film-formed base member 1 to the opposing base plate 4 via the bonding film 3a.

Steps of the bonding method of the present embodiment will be described in a sequential order of the steps.

First, at step 1, as shown in FIG. 9A, the bonding film-formed base member 1 is prepared that includes the bonding film 3a selectively formed in the predetermined region 350 on the upper surface 25 of the base plate 2.

The bonding film-formed base member 1 thus configured can be obtained, for example, by drying and burning the liquid material of the first embodiment selectively supplied in the predetermined region 350 on the upper surface 25. In addition, as an alternative method for obtaining the bonding film-formed base member 1, in the same manner as in the first embodiment, after forming the bonding film 3 on an almost entire part of the upper surface 25, there is formed a mask corresponding to the shape of the predetermined region 350 by photolithography, and then, using the mask, a part of the bonding film 3 positioned in a non-mask region is selectively removed by etching.

Next, at step 2, as shown in FIG. 9B, energy is applied to the bonding film 3a. Thereby, in the bonding film-formed base member 1, the bonding film 3a becomes adhesive to the opposing base plate 4.

Additionally, in the application of energy at the present step, the energy may be selectively applied to the bonding film 3a or may be applied to the entire part of the upper surface 25 of the base plate 2 including the bonding film 3a.

The energy can be applied to the bonding film 3a by any method, such as any of the methods mentioned in the first embodiment, for example.

Next, at step 3, as shown in FIG. 9C, the opposing base plate (the object intended to be bonded together) 4 is prepared. Then, the bonding film-formed base member 1 is bonded to the opposing base plate 4 such that the bonding film 3a closely adheres to the opposing base plate 4, thereby obtaining the bonded structure 5c shown in FIG. 9D.

In the bonded structure 5c thus obtained, without bonding together opposing surfaces of the base plate 2 and the opposing base plate 4, only a partial region (the predetermined region 350) of the base plate 2 is bonded to a part of the opposing base plate 4 corresponding to the partial region. When forming the bonding film 3a, a region to be bonded can be easily selected merely by controlling a region for forming the bonding film 3a. In this manner, for example, a bonding strength of the bonded structure 5c can be easily adjusted by controlling a size of the region for the bonding film 3a (the predetermined region 350). As a result, the bonded structure 5c can be obtained that allows bonded portions to be easily separated, for example.

In addition, local concentration of stress occurring at the bonded portion (the predetermined region 350) between the bonding film-formed base member 1 and the opposing base plate 4 shown in FIG. 9D can be mitigated by appropriately controlling a size and a shape of the bonded portion as the predetermined region 350. This can ensure that the bonding film-formed base member 1 is bonded to the opposing base plate 4 even if there is a significant difference in the thermal expansion coefficient between the base plate 2 and the opposing base plate 4.

Furthermore, between the bonding film-formed base member 1 and the opposing base plate 4 of the bonded structure 5c is formed a space 3c as a clearance corresponding to a thickness of the bonding film 3a in the region except for the predetermined region 350 (See FIG. 9D). Accordingly, adjusting the shape of the predetermined region 350 and the thickness of the bonding film 3a according to need can facilitate formation of a closed space, a flow channel, or the like having an intended shape between the base plate 2 and the opposing base plate 4.

In that manner, the bonded structure 5c can be obtained.

After formation of the bonded structure 5c, at least one of the steps 4A to 4C of the first embodiment may be performed on the bonded structure 5c if necessary.

### Sixth Embodiment

Next will be described a bonding film-formed base member according to a sixth embodiment, a method for bonding the bonding film-formed base member to an opposing base plate according to a sixth embodiment (a bonding method of the sixth embodiment), and a bonded structure including the bonding film-formed base member according to a sixth embodiment.

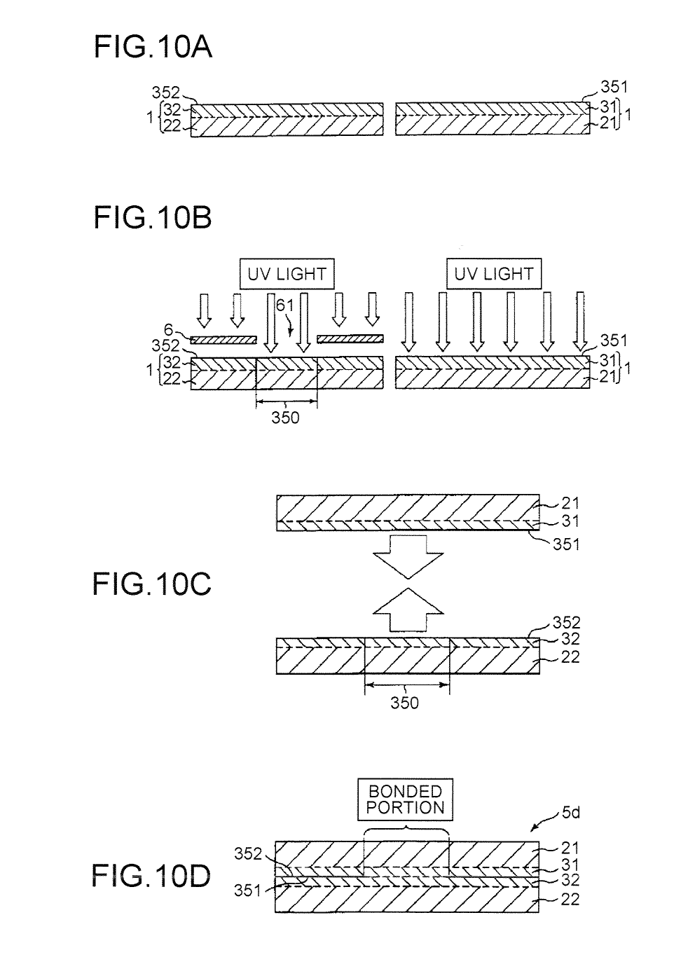

FIGS. 10A to 10D are longitudinal sectional views for illustrating the bonding method of the sixth embodiment using the same two bonding film-formed base members as that of the first embodiment. In the description below, upper and lower sides, respectively, in FIGS. 10A to 10D, will be referred to as “upper” and “lower”, respectively.

Hereinafter, the bonding method of the sixth embodiment will be described. The description will focus on points different from the first to the fifth embodiments, without repeating the same points as in the embodiments.

The bonding method of the sixth embodiment is the same as that of the first embodiment except for following points: In one of the two bonding film-formed base members 1 prepared, only the predetermined region 350 of the bonding film 3 is selectively activated, and thereafter, the two bonding film-formed base members 1 are placed one on top of the other such that the bonding films 31 and 32 of the base members 1 are contacted with each other so as to bond the two bonding film-formed base members 1 together at the predetermined region 350.

Specifically, the bonding method of the sixth embodiment includes preparing the two bonding film-formed base members 1 according to the first embodiment; applying energy to different regions of the respective bonding films 31 and 32 of the bonding film-formed base members 1 to activate the regions; and bonding the two bonding film-formed base members 1 together to obtain a bonded structure 5d formed by partially bonding the two bonding film-formed base members 1 together at the predetermined region 350.

Hereinafter, steps of the bonding method of the present embodiment will be described in a sequential order of the steps.

First, at step 1, similarly to the first embodiment, the two bonding film-formed base members 1 are prepared (See FIG. 10A). As the bonding film-formed base members 1, the present embodiment uses the bonding film-formed base member 1 including the base plate 21 and the bonding film 31 formed on the base plate 21 and the bonding film-formed base member 1 including the base plate 22 and the bonding film 32 formed on the base plate 22, as shown in FIG. 10A.

Next, as shown in FIG. 10B, in one of the two bonding film-formed base members 1, energy is applied to an entire part of the surface 351 of the bonding film 31 to allow the entire part of the surface 351 to have adhesion.

Meanwhile, in the other one of the two bonding film-formed base members 1, energy is selectively applied to the predetermined region 350 on the surface 352 of the bonding film 32. A method for selectively applying energy to the predetermined region 350 may be the same method as in the fourth embodiment, for example.

When energy is applied to each of the bonding films 31 and 32, the leaving group 303 shown in FIG. 3 is eliminated from each of the bonding films 31 and 32. After elimination of the leaving group 303, as shown in FIG. 4, the active bond 304 occurs near each of the surface 351 and 352 of the bonding films 31 and 32, causing activation of the bonding films 31 and 32. Consequently, the entire part of the surface 351 of the bonding film 31 and the predetermined region 350 of the surface 352 of the bonding film 32, respectively, obtain adhesion, whereas a remaining region of the bonding film 32 excluding the predetermined region 350 hardly has adhesion.

The two bonding film-formed base members 1 in the above condition can be partially bonded to each other at the predetermined region 350.

Next, at step 3, as shown in FIG. 10C, the two bonding film-formed base members 1 are bonded together such that the adhesive bonding films 31 and 32 closely adhere to each other, thereby obtaining the bonded structure 5d shown in FIG. 10D.

In the bonded structure 5d thus obtained, instead of bonding together entire opposing surfaces of the two bonding film-formed base members 1, only the partial region (the predetermined region 350) of the surface 352 of the bonding film 32 is bonded to a part of the surface 351 of the bonding film 31. In the above bonding, the region to be bonded can be easily selected merely by controlling the region of the bonding film 32 to which the energy is to be applied. In this manner, for example, a bonding strength of the bonded structure 5d can be easily adjusted.

As a result, the bonded structure 5d can be obtained.

After formation of the bonded structure 5d, at least one of the steps 4A to 4C of the first embodiment may be performed on the bonded structure 5d if necessary.

For example, simultaneous pressurization and heating of the bonded structure 5d allows the base plates 21 and 22 of the bonded structure 5d to come closer to each other. This promotes dehydration condensation of OH groups and re-bonding between broken bonds on the interface between the bonding films 31 and 32. Then, further integration between the bonding films 31 and 32 is progressed at the bonded portion formed on the predetermined region 350, finally resulting in almost complete integration between the bonding films 31 and 32.

At that time, on the interface between the surface 351 of the bonding film 31 and the surface 352 of the bonding film 32, in the region excluding the predetermined region 350, namely in the non-bonded region, a small space is present (remains) between the surfaces 351 and 352. Accordingly, simultaneous pressurization and heating of the bonded structure 5d are preferably performed under the condition where the bonding films 31 and 32 are not bonded to each other in the region excluding the predetermined region 350.

In addition, considering the description above, when performing at least one of the steps 4A to 4C of the first embodiment, the steps are preferably performed selectively to the predetermined region 350. This can prevent bonding between the bonding films 31 and 32 in the region excluding the predetermined region 350.

### Seventh Embodiment

Next will be described a bonding film-formed base member according to a seventh embodiment, a method for bonding the bonding film-formed base member to an opposing base plate according to a seventh embodiment (a bonding method of the seventh embodiment), and a bonded structure including the bonding film-formed base member according to a seventh embodiment.

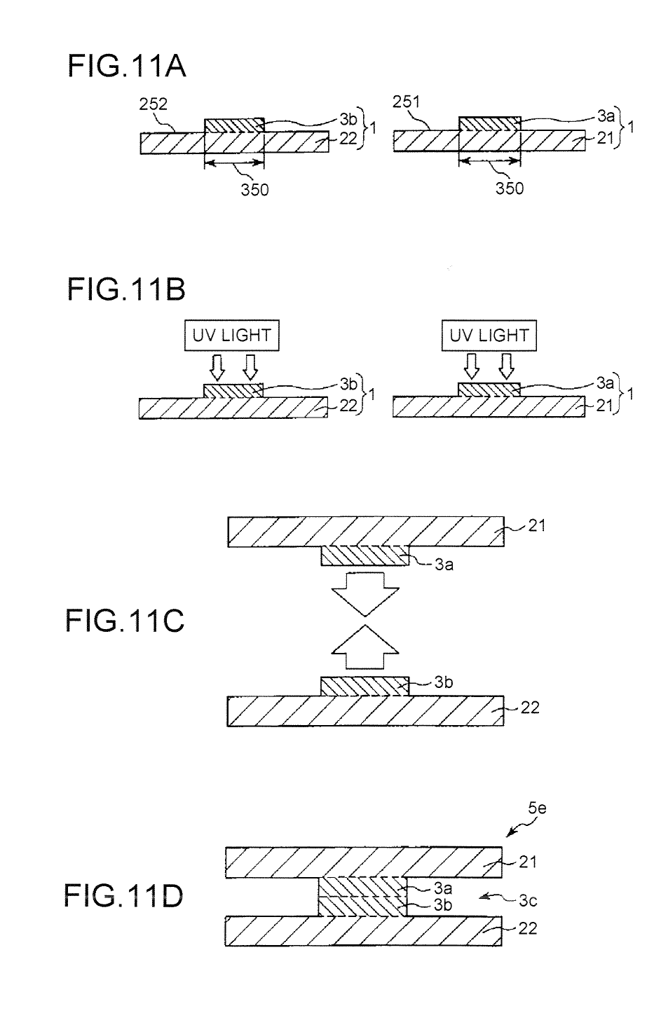

FIGS. 11A to 11D are longitudinal sectional views for illustrating the bonding method of the seventh embodiment using two bonding film-formed base members, each of which is same as that of the modification. In the description below, upper and lower sides, respectively, in FIGS. 11A to 11D, will be referred to as “upper” and “lower”, respectively.

Hereinafter, the bonding method of the seventh embodiment will be described. The description will focus on points different from the first to the sixth embodiments, without repeating the same points as in the embodiments.

The bonding method of the seventh embodiment is the same as that of the first embodiment excepting that the bonding film 3a or 3b is formed selectively only in the predetermined region 350 of each of the upper surfaces 251 and 252 of the base plates 21 and 22 to prepare two bonding film-formed base members 1, and then, the two base members 1 are partially bonded together via the bonding films 3a and 3b.

Specifically, the bonding method of the seventh embodiment includes preparing the two bonding film-formed base members 1 each including each of the base plates 21, 22 and each of the bonding films 3a, 3b formed on the predetermined region 350 of the each base plate; applying energy to each of the bonding films 3a, 3b of each of the bonding film-formed base members 1 to activate the films 3a and 3b; and bonding the two bonding film-formed base members 1 together to obtain a bonded structure 5e formed by partially bonding the two base members 1 together at the predetermined regions 350.

Hereinafter, steps of the bonding method of the present embodiment will be described in a sequential order of the steps.

First, at step 1, as shown in FIG. 11A, the two bonding film-formed base members 1 are prepared. In the two base members 1 prepared, the bonding film 3a is selectively formed on the predetermined region 350 of each of the upper surfaces 251 and 252 of the base plates 21 and 22.

The bonding film-formed base members 1 thus structured can be obtained by the same manner as in the fifth embodiment.

Next, at step 2, as shown in FIG. 1B, energy is applied to the bonding films 3a and 3b, thereby causing the bonding films 3a and 3b of the bonding film-formed base members 1 to have adhesion.

At the present step, energy may be applied selectively to the bonding films 3a and 3b or may be applied to each entire part of the upper surfaces 251 and 252 of the base plates 21 and 22 including the bonding films 3a and 3b.

The energy can be applied to the bonding films 3a and 3b by any method, such as any of the methods mentioned in the first embodiment, for example.

Next, at step 3, as shown in FIG. 11C, the two bonding film-formed base members 1 are bonded together such that the adhesive bonding films 3a and 3b closely adhere to each other, thereby obtaining the bonded structure 5e shown in FIG. 11D.

In the bonded structure 5e thus obtained, instead of bonding together entire opposing surfaces of the two bonding film-formed base members 1, only the partial regions (the predetermined regions 350) are partially bonded together. In the above bonding, the region to be bonded can be easily selected merely by controlling the region of the bonding film 32 to which the energy is to be applied. In this manner, for example, a bonding strength of the bonded structure 5e can be easily adjusted.

Furthermore, between the base plates 21 and 22 of the bonded structure 5e is formed the space 3c as the clearance corresponding to the thickness of the bonding film 3a in the region excluding the predetermined region 350 (See FIG. 11D). Accordingly, adjusting the shape of the predetermined region 350 and the thicknesses of the bonding films 3a and 3b according to need can facilitate formation of a closed space, a flow channel, or the like having an intended shape between the base plates 21 and 22.

In that manner, the bonded structure 5e can be obtained.

After formation of the bonded structure 5e, at least one of the steps 4A to 4C of the first embodiment may be performed on the bonded structure 5e if necessary.

For example, simultaneous pressurization and heating of the bonded structure 5e allows the base plates 21 and 22 of the bonded structure 5e to come closer to each other. This promotes dehydration condensation of OH groups and re-bonding between broken bonds on the interface between the bonding films 31 and 32. Then, further integration between the bonding films 31 and 32 is progressed at the bonded portion formed on the predetermined region 350, finally resulting in almost complete integration between the bonding films 31 and 32.

The bonding methods of the embodiments described above can be used to bond various constituent members together.

Examples of the constituent members to be bonded together by the bonding methods of the embodiments include semiconductor elements such as transistors, diodes, and memories, piezoelectric elements such as liquid crystal oscillators, optical elements such as reflecting mirrors, optical lenses, diffraction gratings, and optical filters, photoelectric converting elements such as solar batteries, micro electro mechanical system (MEMS) components such as semiconductor substrates with semiconductor devices mounted thereon, insulating substrates with wirings or electrodes, inkjet recording heads, micro actors, and micro mirrors, sensor components such as pressure sensors and acceleration sensors, package components of semiconductor elements or electronic components, storage media such as magnetic record media, optical magnetic record media, and optical record media, display element components such as liquid crystal display elements, organic EL elements, and electrophoretic display elements, and fuel cell components.

### Liquid Droplet Discharging Head

Next will be described an inkjet recording head produced by applying the bonded structure of any of the embodiments.

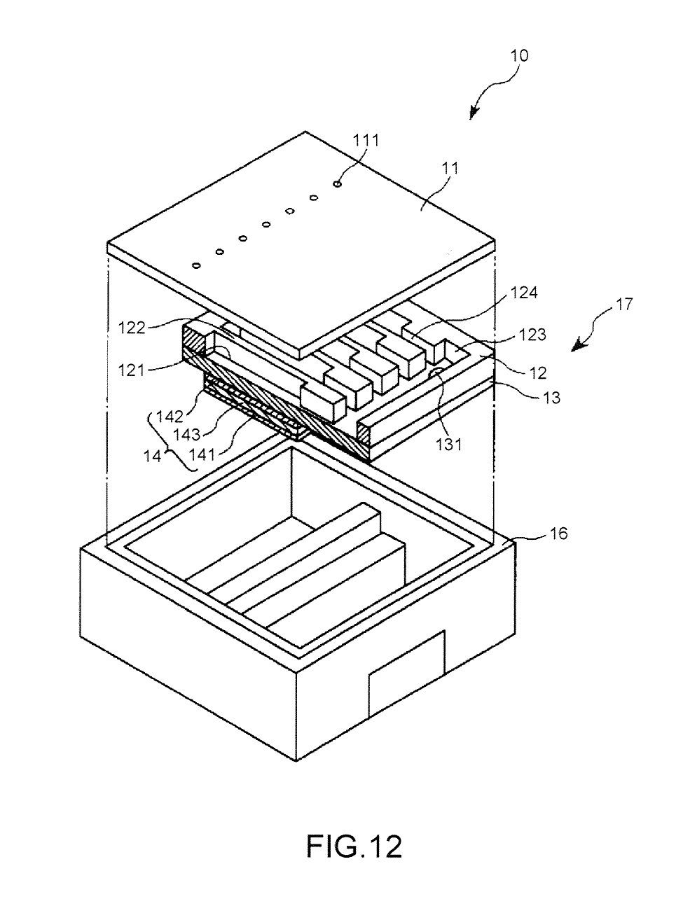

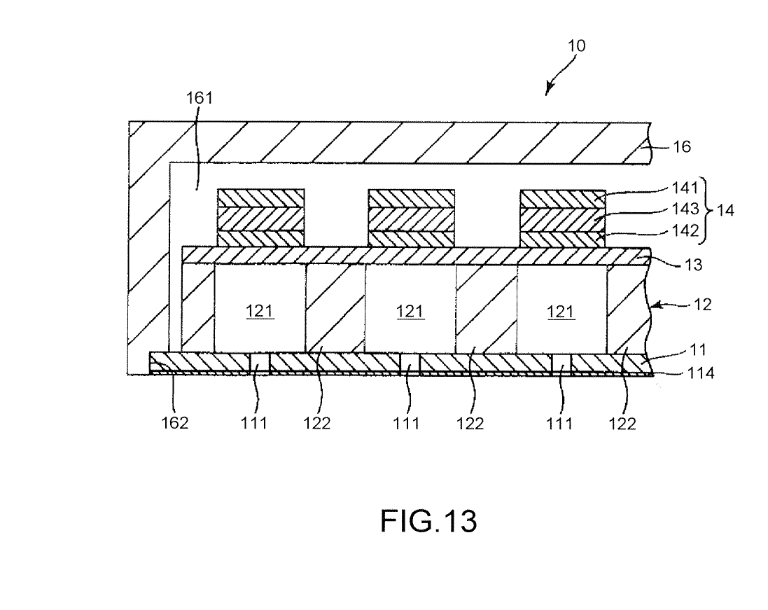

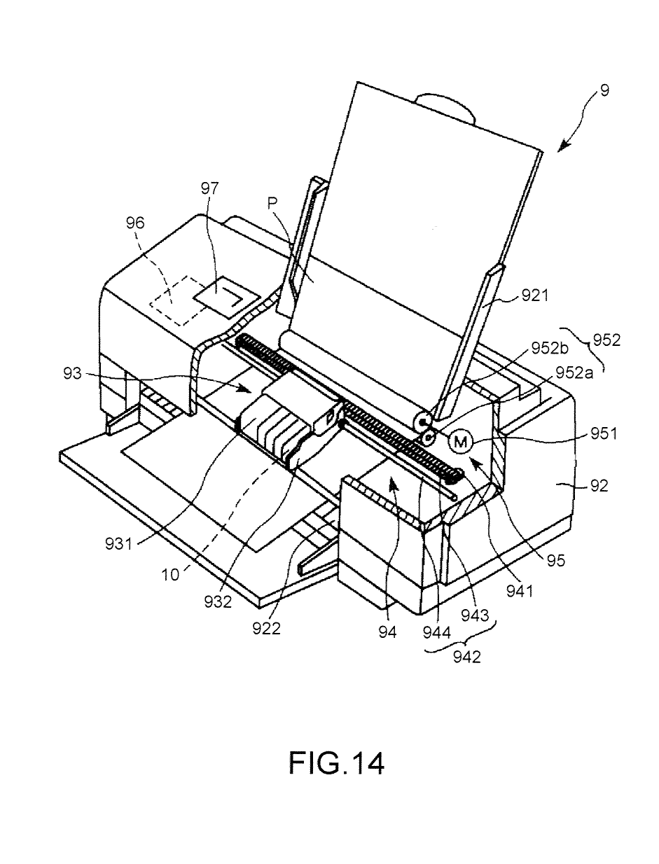

FIG. 12 is an exploded perspective view showing the inkjet recording head (a liquid droplet discharging head) obtained by applying the bonded structure of any of the embodiments; FIG. 13 is a sectional view showing a structure of a main part of the inkjet recording head shown in FIG. 12; and FIG. 14 is a schematic view showing an example of an inkjet printer including the inkjet recording head shown in FIG. 12. In FIG. 12, the inkjet recording head is shown upside down relative to its normal operative position.

An inkjet recording head 10 shown in FIG. 12 is mounted in an inkjet printer 9 as shown in FIG. 14.

The inkjet printer 9 of FIG. 14 includes a main body 92. At an upper rear part of the main body 92 is provided a tray 921 for placing record paper P; at a lower front part thereof is provided a paper ejection outlet 922 for ejecting the record paper P; and on a top surface thereof is provided an operation panel 97.

For example, the operation panel 97 is formed by a liquid crystal display, an organic EL display, an LED lamp, or the like, and includes a display section (not shown) displaying an error message and the like and an operating section (not shown) formed by various kinds of switches and the like.

Inside the main body 92 are mainly provided a printing device (a printing unit) 94 with a reciprocating head unit 93, a paper feeding device (a paper feeding unit) 95 feeding each sheet of the record paper P into the printing device 94, and a controlling section (a controlling unit) 96 controlling the printing device 94 and the paper feeding device 95.

The controlling section 96 controls the paper feeding device 95 to intermittently feed each sheet of the record paper P. The record paper P passes through near a lower part of the head unit 93. During the passing of the record paper P, the head unit 93 reciprocates in a direction approximately orthogonal to a direction for feeding the record paper P to perform printing on the record paper P. In short, reciprocation of the head unit 93 and the intermittent feeding of the record paper P correspond to main scanning and sub-scanning in printing operation to perform inkjet printing.

The printing device 94 includes the head unit 93, a carriage motor 941 as a driving source for the head unit 93, and a reciprocation mechanism 942 allowing reciprocation of the head unit 93 in response to rotating movement of the carriage motor 941.

At the lower part of the head unit 93 are provided an inkjet recording head 10 (hereinafter simply referred to as “head 10”) with a plurality of nozzle holes 111, an ink cartridge 931 supplying ink to the head 10, and a carriage 932 having the head 10 and the ink cartridge 931 mounted thereon.

The ink cartridge 931 includes four color (yellow, cyan, magenta, and black) ink cartridges to perform full-color printing.

The reciprocation mechanism 942 includes a carriage guiding shaft 943 having end portions supported by a frame (not shown) and a timing belt 944 extended in parallel to the carriage guiding shaft 943.

The carriage 932 is reciprocatably supported by the carriage guiding shaft 943 and fixed to a part of the timing belt 944.

With operation of the carriage motor 941, the timing belt 944 runs forward and backward via pulleys, whereby the head unit 93 is guided by the carriage guiding shaft 943 to perform reciprocating motion. During the reciprocating motion, the head 10 discharges ink according to need to perform printing on the record paper P.

The paper feeding device 95 includes a paper feeding motor 951 and a set of paper feeding rollers 952 rotated by operation of the paper feeding motor 951.

The set of paper feeding rollers 952 includes a driven roller 952a and a driving roller 952b that are opposing each other at upper and lower positions while sandwiching a feed channel of the record paper P. The driving roller 952b is coupled to the paper feeding motor 951. Thereby, the paper feeding rollers 952 are configured so as to feed each of multiple sheets of the record paper P placed in the tray 921 to the printing device 94. Instead of the tray 921, there may be removably provided a paper feeding cassette containing the record paper P.

The controlling section 96 controls the printing device 94, the paper feeding device 95, and the like based on print data input from a personal computer, a host computer of a digital camera or the like, for example.

The controlling section 96 mainly includes a memory storing control programs controlling respective sections and the like, a piezoelectric element driving circuit driving piezoelectric elements 14 (a vibration source) to control timing of discharging of the ink, a driving circuit driving the printing device 94 (the carriage motor 941), a driving circuit driving the paper feeding device 95 (the paper feeding motor 951), a communication circuit acquiring the print data from the host computer, and a CPU electrically connected to those components to perform various kinds of controls at the respective sections, although the components are not shown in the drawing.

In addition, for example, the CPU is electrically connected to various kinds of sensors detecting an amount of ink left in each of the ink cartridges 931, a position of the head unit 93, and the like.

The controlling section 96 acquires the print data via the communication circuit to store the data in the memory. The CPU processes the print data to output a driving signal to each driving circuit based on the processed data and input data from the sensors. The driving signal allows each of the piezoelectric elements 14, the printing device 94, and the paper feeding device 95 to be operated, thereby performing printing on the record paper P.

Hereinafter, the head 10 will be described in detail with reference to FIGS. 12 and 13.

The head 10 includes a head main body 17 with a nozzle plate 11, an ink cavity substrate 12, a vibrating plate 13, and the piezoelectric elements 14 (the vibration source) bonded to the vibrating plate 13, and a base body 16 storing the head main body 17. The head 10 forms an on-demand piezo jet head.

For example, the nozzle plate 11 may be made of a silicon material such as SiO₂, SiN, or quartz glass, a metal material such as Al, Fe, Ni, Cu, or an alloy thereof, an oxide material such as alumina or iron oxide, a carbon material such as carbon black or graphite, or the like.

In the nozzle plate 11 are formed the multiple nozzle holes 111 for discharging ink droplets. Pitches between the nozzle holes 111 are appropriately determined in accordance with printing precision.

The ink cavity substrate 12 is adhered (fixed) to the nozzle plate 11.

The ink cavity substrate 12 includes a plurality of ink cavities (namely, pressure cavities) 121, a reservoir 123 storing ink supplied from each ink cartridge 931, and a supply hole 124 supplying the ink to each ink cavity 121 from the reservoir 123. The ink cavities 121, the reservoir 123, and the supply holes 124 are partitioned by the nozzle plate 11, side walls (partition walls) 122, and the vibrating plate 13 described below.

Each ink cavity 121 is formed in a strip shape (a rectangular shape) and arranged corresponding to each nozzle hole 111. A capacity of the each ink cavity 121 can be changed by vibration of the vibrating plate 13 described below. The ink cavity 121 is configured so as to discharge ink by changing of the capacity.

For example, a base material for the ink cavity substrate 12 is a silicon monocrystalline substrate, a glass substrate, a resin substrate, or the like. Those substrates are all for general purpose use. Accordingly, using any one of the substrates can reduce production cost of the head 10.

The vibrating plate 13 is bonded to a side of the ink cavity substrate 12 not facing the nozzle plate 11, and the piezoelectric elements 14 are provided on a side of the vibrating plate 13 not facing the ink cavity substrate 12.

At a predetermined position of the vibrating plate 13 is formed a through-hole 131 penetrating through in a thickness direction of the vibrating plate 13. Ink can be supplied to the reservoir 123 from each ink cartridge 931 via the through-hole 131.

Each of the piezoelectric elements 14 is formed by interposing a piezoelectric layer 143 between a lower electrode 142 and an upper electrode 141 and arranged corresponding to an approximately center part of each ink cavity 121. The each piezoelectric element 14 is electrically connected to the piezoelectric-element driving circuit to be operated (vibrated and deformed) in response to a signal from the piezoelectric-element driving circuit.

The piezoelectric element 14 serves as each vibration source. Vibration of the piezoelectric element 14 allows the vibrating plate 13 to vibrate so as to momentarily increase an internal pressure in the ink cavities 121.

The base body 16 may be made of any one of resin materials, metal materials, and the like. The nozzle plate 11 is fixed to the base body 16 to be supported by the base body 16. Specifically, in a condition where a recessed portion 161 of the base body 16 stores the head main body 17, an edge portion of the nozzle plate 11 is supported by a stepped portion 162 formed at an outer periphery of the recessed portion 161.

The bonding method of any of the embodiments is used for at least one among bonding between the nozzle plate 11 and the ink cavity substrate 12, bonding between the ink cavity substrate 12 and the vibrating plate 13, and bonding between the nozzle plate 11 and the base body 16.

In other words, the bonded structure of any of the embodiments is applied to at least one among a bonded structure of the nozzle plate 11 and the ink cavity substrate 12, a bonded structure of the ink cavity substrate 12 and the vibrating plate 13, and a bonded structure of the nozzle plate 11 and the base body 16.

In the head 10 thus configured, bonded interfaces between bonded portions have high bonding strength and high chemical resistance, thereby improving durability and liquid tightness against ink stored in each ink cavity 121. This makes the head 10 highly reliable.

In addition, since highly reliable bonding is attainable at a very low temperature, there is an advantage that a large-area head can be obtained using materials having different linear expansion coefficients.

In the head 10 thus configured, the each piezoelectric layer 143 is not deformed in a condition where a predetermined discharging signal is not input via the piezoelectric-element driving circuit, namely in a condition where no voltage is applied between the lower and the upper electrodes 142 and 141. Accordingly, the vibrating plate 13 is also not deformed, thus causing no change in the capacity of the ink cavity 121. As a result, no ink droplet is discharged from the nozzle holes 111.

Meanwhile, the piezoelectric layer 143 is deformed when a predetermined signal is input via the piezoelectric-element driving circuit, namely when a predetermined voltage is applied between the electrodes 142 and 141 of the piezoelectric element 14. Thereby, the vibration plate 13 is largely bent, causing a change in the capacity of the ink cavity 121. Then, pressure inside the ink cavity 121 is momentarily increased, which allows discharging of ink droplets form the nozzle holes 111.

After completion of one-time discharging of ink, the piezoelectric-element driving circuit stops applying a voltage between the lower and the upper electrodes 142 and 141. Thereby, the shape of the piezoelectric element 14 returns to an almost original shape, and thus, the capacity of the ink cavity 121 is increased. At that point, ink is under the influence of pressure directing toward each nozzle hole 111 from the ink cartridge 931 (pressure in a forward direction). This prevents entry of air from the nozzle hole 111 into the ink cavity 121, allowing ink having an amount corresponding to an amount of ink to be discharged to be supplied to the ink cavity 121 from the ink cartridge 931 (the reservoir 123).

In this manner, in the head 10, a discharging signal is sequentially input to the piezoelectric element 14 located at an intended position for printing via the piezoelectric-element driving circuit, thereby enabling arbitrary (desired) characters, figures, and the like to be printed.

Additionally, the head 10 may include an electrothermal converting element instead of the piezoelectric element 14. That is, the head 10 may be of the so-called “bubble jet system” (“bubble jet” is a registered trademark) discharging ink by using thermal expansion of a material by the electrothermal converting element.

In the head 10 structured as above, on the nozzle plate 11 is formed a coating film 114 to provide lyophobic properties. This can surely prevent any residual ink droplet from remaining around the nozzle holes 111 when ink droplets are discharged from the nozzle holes 111, thereby ensuring that the ink droplets from the nozzle holes 111 can land on an intended region.

### Wiring Board

Now, a description will be given of a wiring board formed by applying the bonded structure according to any of the embodiments.

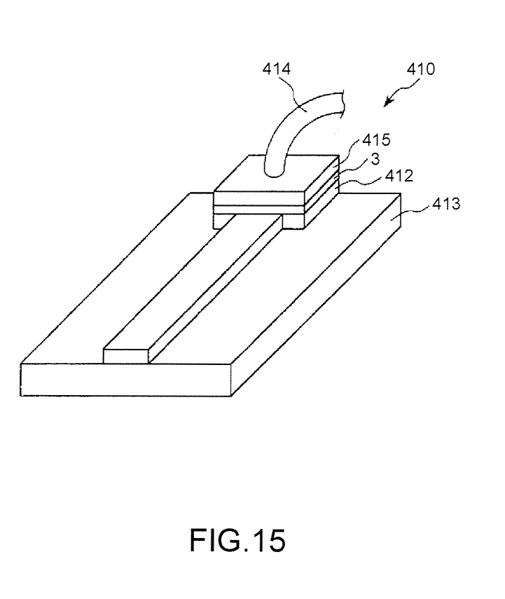

FIG. 15 is a perspective view of the wiring board obtained by applying the bonded structure of the embodiment.

A wiring board 410 shown in FIG. 15 includes an insulating board 413, an electrode 412 provided on the insulating board 413, a lead 414, and an electrode 415 provided at an end of the lead 414 so as to oppose the electrode 412.

The bonding film 3 is formed on each of an upper surface of the electrode 412 and a lower surface of the electrode 415. The bonding films 3 are adhered and bonded together by using the bonding method of any of the embodiments described above. Thus, a presence of a single layer of the bonding films 3 allows strong bonding between the electrodes 412 and 415, thereby ensuring prevention of interlayer separation or the like between the bonding films 3 of the electrodes 412 and 415, as well as achieving formation of the wiring board 410 with high reliability.

In addition, selecting the bonding film 3 including a conductive metal oxide allows the bonding film 3 to serve to provide electrical conduction between the electrodes 412 and 415. The bonding film 3 exhibits sufficient bonding strength even if the film is extremely thin. This allows a space between the electrodes 412 and 415 to be as small as possible, thereby reducing electrical resistance (contact resistance) between the electrodes 412 and 415. As a result, conductivity between the electrodes 412 and 415 can be further increased.

Furthermore, the thickness of the bonding film 3 can be easily controlled with high precision, as described above. Accordingly, the wiring board 410 can be formed with higher size precision, and the conductivity between the electrodes 412 and 415 can also be easily controlled.

Hereinabove, the bonding film-formed base member, the bonding method; and the bonded structure according to the embodiments of the invention have been described based on the drawings. However, the invention is not restricted to the embodiments described above.

For example, the bonding method according to an embodiment of the invention may be an arbitrary one or a combination of arbitrary two or more methods among the bonding methods according to the embodiments above.

In addition, the bonding method of each of the embodiments may further include at least one step for an arbitrary purpose when needed.

Furthermore, each of the embodiments has described the bonding method for bonding together the two base members (the base plate and the opposing base plate). However, three or more base members may be bonded together by using the bonding film-formed base member and the bonding method according to any of the embodiments.

### EXAMPLES

Specific examples of the embodiments will be described.

1. Production of Bonded Structure

### Example 1

First, as a base plate and an opposing base plate, respectively, there were prepared a monocrystalline silicon substrate and a glass substrate, respectively. Each substrate had a length of 20 mm, a width of 20 mm, and an average thickness of 1 mm.

Surface treatment using oxygen plasma was performed on a surface of the monocrystalline silicon substrate.

On the surface of the substrate subjected to the surface treatment, 1.27 mol/L of di-n-butylether solution of Cu(SOPD)₂ (manufactured by Ube Industries, Ltd.) was applied by spin coating, and then dried at 150° C. for 30 minutes. As a result, there was obtained a dry coating film made of Cu(SOPD)₂.

Next, by burning the dry coating film obtained, a bonding film having an average thickness of 100 nm was formed on the surface of the monocrystalline silicon substrate subjected to the surface treatment. Conditions for burning the dry coating film were as follows:

Burning Conditions

Burning Temperature: 270° C.

Atmosphere during Burning: Nitrogen gas

Pressure during Burning: 1×10⁻³ Torr

Burning Time: 10 minutes

The bonding film formed under the conditions included a copper atom as a metal atom and a part of an organic substance contained in Cu(SOPD)₂, in which the a part of the organic substance remained as a leaving group.

Thereby, there was obtained a bonding film-formed base member according to the embodiments, including the bonding film formed on the monocrystalline silicon substrate.

Next, UV light was applied to the obtained bonding film under following conditions.

UV Irradiation Conditions

Composition of Atmospheric Gas: Nitrogen gas

Temperature of Atmospheric Gas: 20° C.

Pressure of Atmospheric Gas: Atmospheric pressure (100 kPa)

Wavelength of UV light: 172 nm

UV irradiation Time: 15 minutes

Meanwhile, surface treatment using oxygen plasma was performed on a surface of the glass substrate (the opposing base plate).

When one minute passed after the UV irradiation, the monocrystalline silicon substrate and the glass substrate were bonded together such that a UV-irradiated surface of the bonding film was contacted with the surface of the glass substrate subjected to the surface treatment, so as to obtain a bonded structure.

Then, the obtained bonded structure was simultaneously pressurized at 10 MPa and heated at 120° C. for 15 minutes, thereby improving the bonding strength of the bonded structure.

### Example 2

There was obtained a bonded structure in the same manner as in Example 1, excepting that the heating temperature in simultaneous pressurization and heating of the bonded structure was changed from 120° C. to 25° C.

### Examples 3 to 8

There was obtained each bonded structure in the same manner as in Example 1 excepting that materials of the base plate and the opposing base plate were changed to materials shown in Table 1.

### Example 9

First, similarly to Example 1, there were prepared a monocrystalline silicon substrate and a glass substrate, respectively, as the base plate and the opposing base plate, respectively, and surface treatment using oxygen plasma was performed on a surface of each substrate.

Next, as in Example 1, a bonding film was formed on the surface-treated surface of the silicon substrate, whereby a bonding film-formed base member was obtained.

Then, the bonding film-formed base member and the glass substrate were placed one on top of the other such that the bonding film of the bonding film-formed base member was contacted with the surface-treated surface of the glass substrate.

Next, UV light was applied to the contacted substrates under conditions as below:

UV Irradiation Conditions

Composition of Atmospheric Gas: Nitrogen gas

Temperature of Atmospheric Gas: 20° C.

Pressure of Atmospheric Gas: Atmospheric pressure (100 kPa)

Wavelength of UV light: 172 nm

UV irradiation Time: 15 minutes

Thereby, the substrates were bonded together to form a bonded structure.

Then, the formed bonded structure was simultaneously pressurized at 10 MPa and heated at 80° C. for 15 minutes, thereby improving the bonding strength of the bonded structure.

### Example 10

First, as a base plate and an opposing base plate, respectively, there were prepared a monocrystalline silicon substrate and a glass substrate, respectively. Each substrate had a length of 20 mm, a width of 20 mm, and an average thickness of 1 mm.

Surface treatment using oxygen plasma was performed on a surface of each of both substrates.

On the surface of each substrate subjected to the surface treatment, 1.27 mol/L of di-n-butylether solution of Cu(SOPD)₂ (manufactured by Ube Industries, Ltd.) was applied by spin coating, and then dried at 150° C. for 30 minutes. As a result, there was obtained a dry coating film made of Cu(SOPD)₂.

Next, by burning each dry coating film obtained, a bonding film having the average thickness of 100 nm was formed on the surface of the each substrate subjected to the surface treatment. Conditions for burning the dry coating films were as follows:

Burning Conditions

Burning Temperature: 270° C.

Atmosphere during Burning: Nitrogen gas

Pressure during Burning: 1×10⁻³ Torr

Burning Time: 10 minutes

The bonding film formed under the conditions included a copper atom as a metal atom and a part of an organic substance contained in Cu(SOPD)₂, which remained as a leaving group.

Next, UV light was applied to the obtained bonding film on the each substrate under following conditions.

UV Irradiation Conditions

Composition of Atmospheric Gas: Nitrogen gas

Temperature of Atmospheric Gas: 20° C.

Pressure of Atmospheric Gas: Atmospheric pressure (100 kPa)

Wavelength of UV light: 172 nm

UV irradiation Time: 15 minutes

In one minute after UV light irradiation, the substrates were bonded together such that the UV-irradiated surfaces of the substrates were contacted with each other to obtain a bonded structure.

The obtained bonded structure was simultaneously pressurized at 10 MPa and heated at 120° C. for 15 minutes, thereby improving the bonding strength of the bonded structure.

### Example 11

There was obtained a bonded structure in the same manner as in Example 10, excepting that the heating temperature in simultaneous pressurization and heating of the bonded structure was changed from 120° C. to 80° C.

### Examples 12 to 17

There was obtained each bonded structure in the same manner as in Example 10 excepting that materials of the base plate and the opposing base plate were changed to materials shown in Table 1.

### Example 18

First, similarly to Example 10, there were prepared a monocrystalline silicon substrate and a glass substrate, respectively, as the base plate and the opposing base plate, respectively, and surface treatment using oxygen plasma was performed on a surface of each substrate.

Next, as in Example 10, a bonding film was formed on each of the surface-treated surfaces of the silicon substrate and the glass substrate, whereby there were obtained two bonding film-formed base members.

The two bonding film-formed base members were laminated together such that both bonding films were contacted with each other, so as to obtain a laminate.

Next, UV light was applied through the glass substrate of the laminate under conditions as below:

UV Irradiation Conditions

Composition of Atmospheric Gas: Nitrogen gas

Temperature of Atmospheric Gas: 20° C.

Pressure of Atmospheric Gas: Atmospheric pressure (100 kPa)

Wavelength of UV light: 172 nm

UV irradiation Time: 15 minutes

Thereby, the substrates were bonded together to form a bonded structure.

Then, the formed bonded structure was simultaneously pressurized at 10 MPa and heated at 80° C. for 15 minutes, thereby improving the bonding strength of the bonded structure.

### Example 19

First, as a base plate and an opposing base plate, respectively, there were prepared a monocrystalline silicon substrate and a glass substrate, respectively. Each substrate had a length of 20 mm, a width of 20 mm, and an average thickness of 1 mm.

Surface treatment using oxygen plasma was performed on a surface of each of both substrates.

On the surface of each substrate subjected to the surface treatment, a dodecylamine solution including a complex of copper formate and dodecylamine expressed by a following chemical formula (2) was applied by spin coating and then dried to form a dry coating film made of the copper formate and dodecylamine complex.

The copper formate and dodecylamine complex expressed by the chemical formula (2) was synthesized as follows.

Synthesis of Copper Formate and Dodecylamine Complex

A mixture (50 g) of copper formate tetrahydrate and copper formate dehydrate was placed in a vacuum thermostatic oven at 55° C. to be dried until weight change stopped. Thereby, copper formate anhydride was obtained. Meanwhile, 20 g of dodecylamine was placed in a sample bottle and was dissolved in a thermostatic oven at 50° C.

Next, the obtained copper formate anhydride (50 mg) was added to the dissolved dodecylamine in the sample bottle. The sample bottle was capped and placed in the thermostatic oven at 50° C. After approximately two hours, a transparent blue solution was obtained.

Then, 30 g of acetonitrile was added to the solution, and crystalline solid was precipitated. The bottle was again capped and placed in the thermostatic oven at 50° C., and after approximately one hour, a transparent blue solution was obtained again.

Next, after taking out from the thermostatic oven, the sample bottle was naturally cooled at room temperature (20° C.) Thereby, needle crystal was obtained. The needle crystal was filtered to be taken out, then washed with acetonitrile, and then, dried in vacuum. As a result, the copper formate and dodecylamine complex expressed by the formula (2) was obtained (yield: 94%).

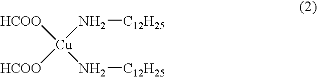

Next, the dry coating film made of the copper formate and dodecylamine complex was burned to form a bonding film having the average thickness of 100 nm on the surface of each of the substrates subjected to the surface treatment. Conditions for burning the dry coating film were as follows:

Burning Conditions

Burning Temperature: 80° C.

Atmosphere during Burning: Argon gas

Pressure during Burning: 1×10⁻⁶ Torr

Burning Time: 5 minutes

The each bonding film formed under the conditions included a copper atom as a metal atom and a part of an organic substance contained in the copper formate and dodecylamine complex. The a part of the organic substance remained as a leaving group.

Next, UV light was applied to the obtained bonding film obtained on each substrate under following conditions. A UV-irradiated region included an entire part of a surface of the bonding film formed on the monocrystalline silicon substrate and a 3-mm-wide frame-like region on a periphery of a surface of the bonding film formed on the glass substrate.

UV Irradiation Conditions

Composition of Atmospheric Gas: Nitrogen gas

Temperature of Atmospheric Gas: 20° C.

Pressure of Atmospheric Gas: Atmospheric pressure (100 kPa)

Wavelength of UV light: 172 nm

UV irradiation Time: 15 minutes

Next, the substrates were bonded together such that the UV-irradiated surfaces of the substrates were contacted with each other, thereby obtaining a bonded structure.

The obtained bonded structure was simultaneously pressurized at 10 MPa and heated at 120° C. for 15 minutes, thereby improving the bonding strength of the bonded structure.

### Example 20

There was obtained a bonded structure in the same manner as in Example 19, excepting that the heating temperature was changed from 120° C. to 80° C.

### Examples 24, 25, and 27

There was obtained each bonded structure in the same manner as in Example 19 excepting that materials of the base plate and the opposing base plate were changed to materials shown in Table 2.

### Example 21

First, as a base plate and an opposing base plate, respectively, there were prepared a monocrystalline silicon substrate and a stainless steel substrate each having a length of 20 mm, a width of 20 mm, and an average thickness of 1 mm, respectively.

Next, surface treatment using oxygen plasma was performed on a surface of the monocrystalline silicon substrate.

As in Example 19, a bonding film having the average thickness of 100 nm was formed on the surface of the monocrystalline silicon substrate subjected to the surface treatment.

Next, UV light was applied to the bonding film, as in Example 19. A UV-irradiated region included a 3-mm-wide frame-like region on a periphery of a surface of the bonding film formed on the silicon substrate.

Then, similarly to the silicon substrate, the stainless steel substrate was also subjected to surface treatment using oxygen plasma.

The silicon substrate and the stainless steel substrate were bonded together such that the UV-irradiated surface of the bonding film was contacted with the surface of the stainless steel substrate subjected to the surface treatment. Thereby, there was obtained a bonded structure.

The obtained bonded structure was simultaneously pressurized at 10 MPa and heated at 120° C. for 15 minutes, thereby improving the bonding strength of the bonded structure.

### Example 22

There was obtained a bonded structure in the same manner as in Example 21 excepting that the heating temperature was changed from 120° C. to 80° C.

### Examples 23, 26, and 28

There was obtained each bonded structure in the same manner as in Example 21 excepting that materials of the base plate and the opposing base plate were changed to materials shown in Table 2.

### Comparative Examples 1 to 3

There was obtained each bonded structure in the same manner as in Example 1, excepting that materials of the base plate and the opposing base plate were materials shown in Table 1 and the base members were adhered to each other with an epoxy adhesive.

### Comparative Examples 4 to 6

There was obtained each bonded structure in the same manner as in Example 1 excepting that materials of the base plate and the opposing base plate were materials shown in Table 1 and the base members were adhered to each other with an Ag paste.

### Comparative Examples 7 to 9

There was obtained each bonded structure in the same manner as in Example 1 excepting that materials of the base plate and the opposing base plate were materials shown in Table 2 and the base members were partially adhered to each other at a peripheral 3-mm-wide frame-like region, with an epoxy adhesive.

2. Evaluation of Bonded Structures 2-1. Evaluation of Bonding Strength (Splitting Strength)

Evaluation was performed on bonding strength of each of the bonded structures obtained by Examples 1 to 18 and Comparative Examples 1 to 6.

Measurements of the bonding strength were carried out by measuring strength obtained immediately before separation of each base member when the base member was separated. Then, each obtained bonding strength was evaluated in accordance with following criteria:

Evaluation Criteria of Bonding Strength

Excellent: 10 MPa (100 kgf/cm²) or larger

Good: 5 MPa (50 kgf/cm²) or larger and smaller than 10 MPa (100 kgf/cm²)

Fair: 1 MPa (10 kgf/cm²) or larger and smaller than 5 MPa (50 kgf/cm²)

Poor: smaller than 1 MPa (10 kgf/cm²)

2.2 Evaluation of Size Precision

Measurements were made regarding size precision in a thickness direction of each of the bonded structures obtained by Examples and Comparative Examples.

The size precision was obtained by measuring a thickness of each corner of a square bonded structure and calculating a difference between a maximum thickness value and a minimum thickness value of the four corners. The calculated difference was evaluated in accordance with following criteria:

Evaluation Criteria of Size Precision

Good: smaller than 10 μm

Poor: 10 μm or larger

2-3. Evaluation of Chemical Resistance

The bonded structures obtained by Examples and Comparative Examples were immersed in inkjet printer ink (“HQ-4” manufactured by Epson, Co. Ltd.) maintained at 80° C. for three weeks under following conditions. After that, each base member was separated to check a presence of ink at a bonded interface. Results were evaluated in accordance with following criteria:

Evaluation Criteria of Chemical Resistance

Excellent: No ink was present.

Good: A slight amount of ink was present in the corner.

Fair: Ink was present along the periphery.

Poor: Ink was present in the interface.

2-4. Evaluation of Resistivity

Measurements were made on resistivity of a bonded portion in each of laminates obtained by Examples 7, 8, 16, and 17 and Comparative Examples 5 and 6. Then, the measured resistivity was evaluated in accordance with following criteria:

Evaluation Criteria of Resistivity

Good: Lower than 1×10⁻³ ohm-cm

Poor: 1×10⁻³ ohm-cm or higher

2-5. Evaluation of Shape Changes

Measurements were made on shape change between before and after formation of the bonded structure in each of Examples 19 to 28 and Comparative Examples 7 to 9.

Specifically, an amount of bending of each bonded structure was measured before and after bonding and was evaluated in accordance with following criteria.

Evaluation Criteria of Bending Amount

Excellent: There was little change in the bending amount before and after bonding.

Good: There was a small change in the bending amount before and after bonding.

Fair: There was a slightly large change in the bending amount before and after bonding.

Poor: There was a very large change in the bending amount before and after bonding.

Hereinafter, Tables 1 and 2 show results of the above evaluations: 2-1 to 2-5

TABLE 1

| | Conditions for producing bonded structure | | | | | | | | | |
|---|---|---|---|---|---|---|---|---|---|---|
| | | Bonding film | | Material of | | | Evaluation results | | | |
| | Material of base | Material | Location | opposing base | | Heating | Bonding | Size | Chemical | |
| | plate | of film | of film | plate | UV irradiation | temperature | strength | precision | resistance | Resistivity |
| Ex 1 | Silicon | Cu(SOPD)₂ | Only on | Glass | Before | 120° C. | Good | Good | Excellent | — |
| Ex 2 | Silicon | | base | Glass | lamination | 25° C. | Good | Good | Good | — |
| Ex 3 | Silicon | | plate | Aluminum | | 120° C. | Good | Good | Excellent | — |
| Ex 4 | Silicon | | | PET | | 120° C. | Excellent | Good | Excellent | — |
| Ex 5 | Glass | | | Stainless steel | | 120° C. | Good | Good | Excellent | — |
| Ex 6 | Stainless steel | | | PET | | 120° C. | Excellent | Good | Excellent | — |
| Ex 7 | Stainless steel | | | Aluminum | | 120° C. | Excellent | Good | Excellent | Good |
| Ex 8 | Stainless steel | | | Stainless steel | | 120° C. | Good | Good | Excellent | Good |
| Ex 9 | Silicon | | | Glass | After lamination | 80° C. | Good | Good | Excellent | — |
| Ex 10 | Silicon | | On both | Glass | Before | 120° C. | Good | Good | Excellent | — |
| Ex 11 | Silicon | | base | Glass | lamination | 80° C. | Good | Good | Good | — |
| Ex 12 | Silicon | | plate and | Aluminum | | 120° C. | Good | Good | Excellent | — |
| Ex 13 | Silicon | | opposing | PET | | 120° C. | Excellent | Good | Excellent | — |
| Ex 14 | Glass | | base | Stainless steel | | 120° C. | Good | Good | Excellent | — |
| Ex 15 | Stainless steel | | plate | PET | | 120° C. | Excellent | Good | Excellent | — |
| Ex 16 | Stainless steel | | | Aluminum | | 120° C. | Excellent | Good | Excellent | Good |
| Ex 17 | Stainless steel | | | Stainless steel | | 120° C. | Good | Good | Excellent | Good |
| Ex 18 | Silicon | | | Glass | After lamination | 80° C. | Good | Good | Good | — |
| Cp 1 | Silicon | Epoxy | — | Glass | — | — | Fair | Poor | Fair | — |
| Cp 2 | Silicon | adhesive | | Silicon | | | Fair | Poor | Fair | — |
| Cp 3 | Silicon | | | Stainless steel | | | Fair | Poor | Fair | — |
| Cp 4 | Stainless steel | Conductive | — | Glass | — | — | Fair | Poor | Fair | — |
| Cp 5 | Stainless steel | (Ag) | | Aluminum | | | Fair | Poor | Fair | Poor |
| Cp 6 | Stainless steel | paste | | Stainless steel | | | Fair | Poor | Fair | Poor |

*Note: Ex and Cp represent Example and Comparative Example; and PET represents polyethylene terephthalate.

TABLE 2

| | Conditions for producing bonded structure | | | | | | | Evaluation results | | |
|---|---|---|---|---|---|---|---|---|---|---|
| | | Bonding film | | | Material of | | | | | Change of |
| | Material of | | Bonded | | opposing base | UV | Heating | Size | Chemical | bending |
| | base plate | Material of film | region | Location of film | plate | irradiation | temperature | precision | resistance | amount |
| Ex 19 | Silicon | Complex of | Part of | On both base | Glass | Before | 120° C. | Good | Excellent | Good |
| | | copper | surface of | plate and | | lamination | | | | |
| | | formate & | film | opposing base | | | | | | |
| | | dodecylamine | | plate | | | | | | |
| Ex 20 | Silicon | | | On both base | Glass | | 80° C. | Good | Good | Excellent |
| | | | | plate and | | | | | | |
| | | | | opposing base | | | | | | |
| | | | | plate | | | | | | |
| Ex 21 | Silicon | | | Only on base | Stainless steel | | 120° C. | Good | Excellent | Good |
| | | | | plate | | | | | | |
| Ex 22 | Silicon | | | Only on base | Stainless steel | | 80° C. | Good | Good | Excellent |
| | | | | plate | | | | | | |
| Ex 23 | Silicon | | | Only on base | Aluminum | | 120° C. | Good | Excellent | Good |
| | | | | plate | | | | | | |
| Ex 24 | Silicon | | | On both base | PET | | 120° C. | Good | Excellent | Good |
| | | | | plate and | | | | | | |
| | | | | opposing base | | | | | | |
| | | | | plate | | | | | | |
| Ex 25 | Glass | | | On both base | Glass | | 120° C. | Good | Excellent | Excellent |
| | | | | plate and | | | | | | |
| | | | | opposing base | | | | | | |
| | | | | plate | | | | | | |
| Ex 26 | Glass | | | Only on base | Stainless steel | | 120° C. | Good | Excellent | Good |
| | | | | plate | | | | | | |
| Ex 27 | Stainless | | | On both base | PET | | 120° C. | Good | Excellent | Good |
| | steel | | | plate and | | | | | | |
| | | | | opposing base | | | | | | |
| | | | | plate | | | | | | |
| Ex 28 | Stainless | | | Only on base | Aluminum | | 120° C. | Good | Excellent | Excellent |
| | steel | | | plate | | | | | | |
| Cp 7 | Silicon | Epoxy | Part of | — | Glass | — | — | Poor | Fair | Excellent |
| Cp 8 | Silicon | adhesive | surface of | | Silicon | | | Poor | Fair | Excellent |
| Cp 9 | Silicon | | film | | Stainless steel | | | Poor | Fair | Good |

*Note: Ex and Cp represent Example and Comparative Example; and PET represents polyethylene terephthalate.

As shown in Tables 1 and 2, the bonded structures obtained in Examples exhibited excellent characteristics in all items of bonding strength, size precision, chemical resistance, and resistivity.

In addition, changes in bending amounts in the bonded structures obtained in Examples were smaller than in Comparative Examples.

On the other hand, the bonded structures obtained in Comparative Examples were not sufficiently chemically resistant, and had particularly low size precision. Furthermore, the bonded structures of Comparative Examples exhibited high resistivity.

What is claimed is:

1. A bonding film-formed base member, comprising:
a base member; and
a bonding film formed by supplying a liquid material containing a metal complex on a surface of the base member and then drying and burning the liquid material, the bonding film including a metal atom and a leaving group made of an organic component,
wherein energy is applied to at least a partial region of a surface of the bonding film to eliminate the leaving group present near the surface of the bonding film from the bonding film so as to allow the at least a partial region of the surface to have adhesion to an object intended to be bonded to the bonding film-formed base member.

2. The bonding film-formed base member according to claim 1, wherein the leaving group is a part of an organic substance included in the metal complex of the liquid material and remains in the bonding film formed by burning the liquid material.

3. The bonding film-formed base member according to claim 1, wherein the liquid material is burned at a temperature ranging from 70 to 300° C.

4. The bonding film-formed base member according to claim 1, wherein the liquid material is burned under an inert gas atmosphere.

5. The bonding film-formed base member according to claim 1, wherein the liquid material is burned under a pressure less than atmospheric pressure.

6. The bonding film-formed base member according to claim 1, wherein the leaving group includes an atomic group having a carbon atom as an essential component and at least one of a hydrogen atom, a nitrogen atom, an oxygen atom, a phosphorous atom, a sulfur atom, and a halogen atom.

7. The bonding film-formed base member according to claim 6, wherein the leaving group includes an alkyl group as the atomic group.

8. The bonding film-formed base member according to claim 1, wherein the metal atom is at least one of copper, aluminum, zinc, iron, and ruthenium.

9. The bonding film-formed base member according to claim 1, wherein a ratio between the metal atom and a carbon atom included in the bonding film ranges from 3:7 to 7:3.

10. The bonding film-formed base member according to claim 1, wherein the bonding film has conductivity.

11. The bonding film-formed base member according to claim 1, wherein after the leaving group present at least near the surface of the bonding film is eliminated from the bonding film, an active bond occurs on the surface of the bonding film.

12. The bonding film-formed base member according to claim 11, wherein the active bond is a dangling bond or a hydroxyl group.

13. The bonding film-formed base member according to claim 1, wherein the bonding film has an average thickness of 1 to 1000 nm.

14. The bonding film-formed base member according to claim 1, wherein the bonding film is a solid having no fluidity.

15. The bonding film-formed base member according to claim 1, wherein the base member is plate-shaped.

16. The bonding film-formed base member according to claim 1, wherein at least a region of the base member where the bonding film is to be formed is mainly made of silicon, metal, or glass.

17. The bonding film-formed base member according to claim 1, wherein a surface treatment for increasing adhesion to the bonding film is performed in advance on the surface of the base member where the bonding film is to be formed.

18. The bonding film-formed base member according to claim 17, wherein the surface treatment is a plasma treatment.

19. The bonding film-formed base member according to claim 1 further including an intermediate layer provided between the base member and the bonding film.

20. The bonding film-formed base member according to claim 1, wherein the intermediate layer is mainly made of an oxide material.

21. A bonding method, comprising:
preparing the bonding film-formed base member according to claim 1 and the object intended to be bonded together;
applying energy to at least a partial region of the bonding film included in the bonding film-formed base member; and
bonding the bonding film-formed base member and the intended object together such that the bonding film closely adheres to the intended object so as to obtain a bonded structure.

22. A bonding method, comprising:
preparing the bonding film-formed base member according to claim 1 and the object intended to be bonded together;
laminating the bonding film-formed base member and the intended object together such that the bonding film closely contacts with the intended object so as to obtain a laminate; and
applying energy to at least a partial region of the bonding film included in the laminate to bond the bonding film-formed base member and the intended object together so as to obtain a bonded structure.

23. The bonding method according to claim 21, wherein the energy is applied by using at least one method among application of an energy beam to the bonding film, heating of the bonding film, and application of a compressive force to the bonding film.

24. The bonding method according to claim 23, wherein the energy beam is UV light having a wavelength of 126 to 300 nm.

25. The bonding method according to claim 23, wherein a heating temperature ranges from 25 to 200° C.

26. The bonding method according to claim 23, wherein the compressive force ranges from 0.2 to 10 MPa.

27. The bonding method according to claim 21, wherein the energy is applied under an air atmosphere.

28. The bonding method according to claim 21, wherein the object intended to be bonded together has a surface that is in advance subjected to a surface treatment for increasing adhesion to the bonding film; and the bonding film-formed base member is bonded to the intended object such that the bonding film closely adheres to the surface of the intended object subjected to the surface treatment.

29. The bonding method according to claim 21, wherein the object intended to be bonded together has, in advance, a surface including at least one group or substance selected from a functional group, a radical, an open-circular molecule, an unsaturated bond, a halogen, and a peroxide; and the bonding film-formed base member is bonded to the intended object such that the bonding film closely adheres to the surface of the intended object including the at least one group or substance.

30. The bonding method according to claim 21 further including performing a treatment for increasing bonding strength of the bonded structure for the bonded structure.

31. The bonding method according to claim 30, wherein the treatment for increasing the bonding strength includes at least one method among application of an energy beam to the bonded structure, heating of the bonded structure, and application of a compressive force to the bonded structure.

32. A bonded structure including the bonding film-formed base member according to claim 1 and an object bonded to the bonding film-formed base member via the bonding film.

33. A bonded structure including two bonding film-formed base members, each of which is same as the bonding film-formed base member according to claim 1, the two bonding film-formed base members being bonded together such that the bonding films of the base members are opposed to each other.
